(19) United States
(12) Patent Application Publication
(10) Pub. No.: US 2017/0109299 A1
(43) Pub. Date: Apr. 20, 2017

(54) NETWORK COMPUTING ELEMENTS, MEMORY INTERFACES AND NETWORK CONNECTIONS TO SUCH ELEMENTS, AND RELATED SYSTEMS

(71) Applicants: Stephen Belair, Santa Clara, CA (US); Parin Dalal, Milpitas, CA (US); Dan Alvarez, San Jose, CA (US)

(72) Inventors: Stephen Belair, Santa Clara, CA (US); Parin Dalal, Milpitas, CA (US); Dan Alvarez, San Jose, CA (US)

(21) Appl. No.: 15/283,287

(22) Filed: Sep. 30, 2016

Related U.S. Application Data
(63) Continuation of application No. PCT/US15/23730, filed on Mar. 31, 2015.
Application No. PCT/US15/23730 is a continuation of application No. PCT/US15/23746, filed on Mar. 31, 2015.
(60) Provisional application No. 61/973,205, filed on Mar. 31, 2014.
(60) Provisional application No. 61/973,207, filed on Mar. 31, 2014.
(60) Provisional application No. 61/976,471, filed on Apr. 7, 2014.

(51) Int. Cl. G06F 13/16; G06F 13/40; G06F 13/28

(52) U.S. Cl. CPC G06F 13/1668; G06F 13/28; G06F 13/4068

(57) ABSTRACT

A system can include at least one computing module comprising a physical interface for connection to a memory bus, a processing section configured to decode at least a predetermined range of physical address signals received over the memory bus into computing instructions for the computing module, and at least one computing element configured to execute the computing instructions.

### PRIORITY CLAIMS

This application is a continuation of Patent Cooperation Treaty (PCT) Application No. PCT/US2015/023730 filed Mar. 31, 2015 which claims the benefit of U.S. Provisional Patent Application No. 61/973,205 filed Mar. 31, 2014 and a continuation of PCT Application No. PCT/US2015/023746 which claims the benefit of U.S. Provisional Patent Applications No. 61/973,207 filed Mar. 31, 2014 and No. 61/976,471 filed Apr. 7, 2014, the contents all of which are incorporated by reference herein.

### TECHNICAL FIELD

The present invention relates generally to network appliances that can be included in servers, and more particularly to network appliances that can include computing modules with multiple ports for interconnection with other servers or other computing modules.

### BACKGROUND

Networked applications often run on dedicated servers that support an associated “state” for context or session-defined application. Servers can run multiple applications, each associated with a specific state running on the server. Common server applications include an Apache web server, a MySQL database application, PHP hypertext preprocessing, video or audio processing with Kaltura supported software, packet filters, application cache, management and application switches, accounting, analytics, and logging.

Unfortunately, servers can be limited by computational and memory storage costs associated with switching between applications. When multiple applications are constantly required to be available, the overhead associated with storing the session state of each application can result in poor performance due to constant switching between applications. Dividing applications between multiple processor cores can help alleviate the application switching problem, but does not eliminate it, since even advanced processors often only have eight to sixteen cores, while hundreds of application or session states may be required.

### BRIEF DESCRIPTION OF THE DRAWINGS

FIG. 1 is a block schematic diagram of a system according to an embodiment.

FIG. 2 is a block schematic diagram of a system according to another embodiment.

FIG. 3 is a block diagram of a memory bus attached computing module that can be included in embodiments.

FIG. 4 is a block diagram of a computing module (XIMM) that can be included in embodiments.

FIG. 5 is a diagram showing XIMM address mapping according to an embodiment.

FIG. 6 is a diagram showing separate read/write address ranges for XIMMs according to an embodiment.

FIG. 7 is a block schematic diagram of a system according to another embodiment.

FIG. 8 is a block schematic diagram of a system according to a further embodiment.

FIG. 9 is a block diagram of XIMM address memory space mapping according to an embodiment.

FIG. 10 is a flow diagram of a XIMM data transfer process according to an embodiment.

FIG. 11 is a flow diagram of a XIMM data transfer process according to another embodiment.

FIG. 12 is block schematic diagram showing data transfers in a system according to embodiments.

FIG. 13 is a diagram showing a XIMM according to another embodiment.

FIG. 14 is a timing diagram of a conventional memory access.

FIGS. 15A to 15F are timing diagrams showing XIMM accesses according to various embodiments. FIG. 15A shows a XIMM access over a double data rate (DDR) interface according to an embodiment. FIG. 15B shows a XIMM access over a DDR interface according to another embodiment. FIG. 15C shows a XIMM access over a DDR interface according to a further embodiment. FIG. 15D shows a XIMM access over a DDR interface according to another embodiment. FIG. 15E shows a XIMM access over a DDR interface according to another embodiment. FIG. 15F shows XIMM access operations according to a more general embodiment.

FIGS. 16A to 16C are diagrams showing a XIMM clock synchronization according to an embodiment. FIG. 16A shows a request encoder discovering a XIMM according to an embodiment. FIG. 16B shows a request encoder supplying a base clock to a XIMM according to an embodiment. FIG. 16C shows a request encoder sending a timestamp to a XIMM according to an embodiment.

FIG. 17 is a flow diagram of a method according to an embodiment.

FIG. 18 is a block schematic diagram of a computing infrastructure according to an embodiment.

FIG. 19 is a block schematic diagram of a computing infrastructure according to another embodiment.

FIG. 20 is a block schematic diagram showing a resource allocation operation according to an embodiment.

FIG. 21 is a diagram showing cluster management in a server appliance according to an embodiment.

FIG. 22 is a diagram showing programs of a compute element processor according to an embodiment.

FIG. 23 is a diagram of a resource map for a software defined infrastructure (SDI) according to an embodiment.

FIG. 24 is a diagram of a computing operation according to an embodiment.

FIG. 25 is a diagram showing a process for an SDI according to an embodiment.

FIG. 26 is a diagram showing a resource mapping transformation according to an embodiment.

FIG. 27 is a diagram showing a method according to an embodiment.

FIG. 28 is a diagram showing a software architecture according to an embodiment.

FIGS. 29A and 29B are diagrams showing computing modules according to embodiment. FIG. 29A shows a computational intensive XIMM according to an embodiment. FIG. 29B shows a storage intensive XIMM according to an embodiment.

FIG. 30 is a diagram of a server appliance according to an embodiment.

FIG. 31 is a diagram of a server according to an embodiment.

FIGS. 32-40 show various XIMM connection configurations.

FIG. 32 is a diagram showing a computing module (XIMM) according to an embodiment.

FIG. 33 is a diagram showing a discovery/detection phase for a XIMM according to an embodiment.

FIG. 34 is a diagram showing a XIMM in a host mode according to an embodiment.

FIG. 35 is a diagram showing a XIMM in a host mode according to another embodiment.

FIG. 36 is a diagram showing a XIMM initiating sessions according to an embodiment.

FIG. 37 is a diagram showing a XIMM in a top-of-rack (TOR) host masquerading mode according to an embodiment.

FIG. 38 is a diagram showing a XIMM in a multi-node mode according to an embodiment.

FIG. 39 is a diagram showing a XIMM in a multi-node mode according to another embodiment.

FIG. 40A to 40C show XIMM equipped network appliances and configurations according to embodiments. FIG. 40A shows a XIMM equipped network appliance where computation/storage elements (CE/SEs) are configured with multiple network interfaces. FIG. 40B shows a CE/SE that can be included in the appliance of FIG. 40A. FIG. 40C shows an arbiter on a XIMM configured as a level 2 switch for CE/SEs of the XIMM. FIG. 40D shows a network interface card (NIC) extension mode for a XIMM equipped network appliance.

### DETAILED DESCRIPTION

Embodiments disclosed herein show appliances with computing elements for use in network server devices. The appliance can include multiple connection points for rapid and flexible processing of data by the computing elements. Such connection points can include, but are not limited to, a network connection and/or a memory bus connection. In some embodiments, computing elements can be memory bus connected devices, having one or more wired network connection points, as well as processors for data processing operations. Embodiments can further include the networking of appliances via the multiple connections, to enable various different modes of operation. Still other embodiments include larger systems that can incorporate such computing elements, including heterogeneous architecture which can include both conventional servers as well as servers deploying the appliances.

In some embodiments, appliances can be systems having a computing module attached to a memory bus to execute operations according to compute requests included in at least the address signals received over the memory bus. In particular embodiments, the address signals can be the physical addresses of system memory space. Memory bus attached computing modules can include processing sections to decode computing requests from received addresses, as well as computing elements for performing such computing requests.

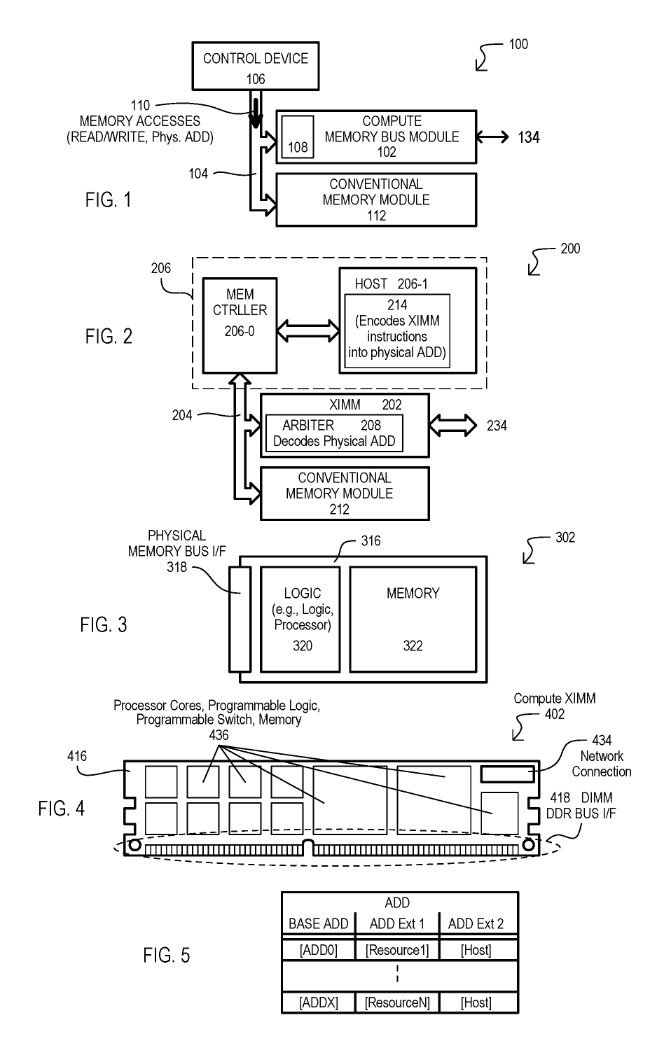

FIG. 1 shows an appliance 100 according to an embodiment. An appliance 100 can include one or more memory bus attached computing modules (one shown as 102), a memory bus 104, and a controller device 106. Each computing module 102 can include a processing section 108 which can decode signals 110 received over the memory bus 104 into computing requests to be performed by computing module 102. In particular embodiments, processing section 108 can decode all or a portion of a physical address of a memory space to arrive at computing requests to be performed. A computing module 102 can include various other components, including memory devices, programmable logic, or custom logic, as but a few examples.

In some embodiments, a computing module 102 can include also include a network connection 134. Thus, computing elements in the computing module 102 can be accessed via memory bus 104 and/or network connection. In particular embodiments, a network connection 134 can be a wired or wireless connection.

Optionally, a system 100 can include one or more conventional memory devices 112 attached to the memory bus 104. Conventional memory device 112 can have storage locations corresponding to physical addresses received over memory bus 104.

According to embodiments, computing module 102 can be accessible via interfaces and/or protocols generated from other devices and processes, which are encoded into memory bus signals. Such signals can take the form of memory device requests, but are effectively operational requests for execution by a computing module 102.

FIG. 2 shows an appliance 200 according to another embodiment. In particular embodiments, an appliance 200 can be one implementation of that shown in FIG. 1. Appliance 200 can include a control device 206 connected to a computing module 202 by a bus 204. A computing module 202 will be referred to herein as a “XIMM”. Optionally, appliance can further include a memory module 212.

In some embodiments, a XIMM 202 can include a physical interface compatible with an existing memory bus standard. In particular embodiments, a XIMM 202 can include an interface compatible with a dual-in line memory module (DIMM) type memory bus. In very particular embodiments, a XIMM 202 can operate according to a double data rate (DDR) type memory interface (e.g., DDR3, DDR4). However, in alternate embodiments, a XIMM 202 can be compatible with any other suitable memory bus. Other memory buses can include, without limitation, memory buses with separate read and write data buses and/or non-multiplexed addresses. In the embodiment shown, among various other components, a XIMM 202 can include an arbiter circuit 208. An arbiter circuit 208 can decode physical addresses into compute operation requests, in addition to various other functions on the XIMM 202).

A XIMM 202 can also include one or more other non-memory interfaces 234. In particular embodiments, non-memory interfaces 234 can be network interfaces to enable one or more a physical network connections to the XIMM 202.

Accordingly, a XIMM 202 can be conceptualized as having multiple ports composed of the host-device—XIMM interface over memory bus 204, as well as non-memory interface(s) 234.

In the embodiment shown, control device 206 can include a memory controller 206-0 and a host 206-1. A memory controller 206-0 can generate memory access signals on memory bus 204 according to requests issued from host device 206-1 (or some other device). As noted, in particular embodiments, a memory controller 206-0 can be a DDR type controller attached to a DIMM type memory bus.

A host device 206-1 can receive and/or generate computing requests based on an application program or the like. A host device 206-1 can include a request encoder 214. A request encoder 214 can encode computing operation requests into memory requests executable by memory controller 206-0. Thus, a request encoder 214 and memory controller 206-0 can be conceptualized as forming a host device-XIMM interface. According to embodiments, a host device-XIMM interface can be a lowest level protocol in a hierarchy of protocols to enable a host device to access a XIMM 202.

In particular embodiments, a host device-XIMM interface can encapsulate the interface and semantics of accesses used in reads and writes initiated by the host device 206-1 to do any of: initiate, control, configure computing operations of XIMMs 202. At the interface level, XIMMs 202 can appear to a host device 206-1 as memory devices having a base physical address and some memory address range (i.e., the XIMM has some size, but it is understood that the size represents accessible operations rather than storage locations).

Optionally, a system 200 can also include a conventional memory module 212. In a particular embodiment, memory module 212 can be a DIMM.

In some embodiments, an appliance 200 can include multiple memory channels accessible by a memory controller 206-0. A XIMM 202 can reside on a particular memory channel, and accesses to XIMM 202 can go through the memory controller 206-0 for the channel that a XIMM 202 resides on. There can be multiple XIMMs on a same channel, or one or more XIMMs on different channels.

According to some embodiments, accesses to a XIMM 202 can go through the same operations as those executed for accessing storage locations of a conventional memory module 212 residing on the channel (or that could reside on the channel). However, such accesses vary substantially from conventional memory access operations. Based on address information, an arbiter 208 within a XIMM 202 can respond to a host device memory access like a conventional memory module 212. However, within a XIMM 202 such an access can identify one or more targeted resources of the XIMM 202 (input/output queues, a scatter-list for DMA, etc.) and the identification of what device is mastering the transaction (e.g., host device, network interface (NIC), or other bus attached device such as a peripheral component interconnect (PCI) type device). Viewed this way, such accesses of a XIMM 202 can be conceptualized as encoding the semantics of the access into a physical address.

According to some embodiments, a host device-XIMM protocol can be in contrast to many conventional communication protocols. In conventional protocols, there can be an outer layer-2 (L2) header which expresses the semantics of an access over the physical communication medium. In contrast, according to some embodiments, a host device-XIMM interface can depart from such conventional approaches in that communication occurs over a memory bus, and in particular embodiments, can be mediated by a memory controller (e.g., 206-0). Thus, according to some embodiments, all or a portion of a physical memory address can serve as a substitute of the L2 header in the communication between the host device 206-1 and a XIMM 202. Further, an address decode performed by an arbiter 208 within the XIMM 202 can be a substitute for an L2 header decode for a particular access (where such decoding can take into account the type of access (read or write)).

FIG. 3 is a block schematic diagram of a XIMM 302 according to one embodiment. A XIMM 302 can be formed on a structure 316 which includes a physical interface 318 for connection to a memory bus. A XIMM 302 can include logic 320 and memory 322. Logic 320 can include circuits for performing functions of a processing section (e.g., 108 in FIG. 1) and/or arbiter (e.g., 208 in FIG. 2), including but not limited to processor and logic, including programmable logic and/or custom logic. Memory 322 can include any suitable memory, including DRAM, static RAM (SRAM), and nonvolatile memory (e.g., flash electrically erasable and programmable read only memory, EEPROM), as but a few examples. However, as noted above, unlike a conventional memory module, addresses received at physical interface 318 do not directly map to storage locations within memory 322, but rather are decoded into computing operations. Such computing operations may require a persistent state, which can be maintained in 322. In very particular embodiments, a XIMM 302 can be one implementation of that shown in FIG. 1 or 2 (i.e., 102, 202).

FIG. 4 is a diagram of a XIMM 402 according to another embodiment. A XIMM 402 can include a printed circuit board 416 that includes a DIMM type physical interface 418. Mounted on the XIMM 402 can be circuit components 436, which in the embodiment shown can include processor cores, programmable logic, a programmable switch (e.g., network switch) and memory (as described for other embodiments herein). In addition, the XIMM 402 of FIG. 4 can further include a network connection 434. A network connection 434 can enable a physical connection to a network. In some embodiments, this can include a wired network connection compatible with IEEE 802 and related standards. However, in other embodiments, a network connection 434 can be any other suitable wired connection and/or a wireless connection. In very particular embodiments, a XIMM 302 can be one implementation of that shown in FIG. 1 or 2 (i.e., 102, 202).

As disclosed herein, according to embodiments, a physical memory addresses received by a XIMM can start or modify operations of the XIMM. FIG. 5 shows one example of XIMM address encoding according to one particular embodiment. A base portion of the physical address (BASE ADD) can identify a particular XIMM. A next portion of the address (ADD Ext1) can identify a resource of the XIMM. A next portion of the address (ADD Ext2) can identify a “host” source for the transaction (e.g., host device, NIC or other device, such as a PCI attached device).

According to embodiments, XIMMs can have read addresses that are different than their write addresses. In some embodiments, XIMMs can be accessed by memory controllers with a global write buffer (GWB) or another similar memory caching structure. Such a memory controller can service read requests from its GWB when the address of a read matches the address of a write in the GWB. Such optimizations may not be suitable for XIMM accesses in some embodiments, since XIMMs are not conventional memory devices. For example, a write to a XIMM can update the internal state of the XIMM, and a subsequent read would have to follow after the write has been performed at the XIMM (i.e., such accesses have to performed at the XIMM, not at the memory controller). In some particular embodiments, a same XIMM can have different read and write address ranges. In such an arrangement, reads from a XIMM that have been written to will not return data from the GWB.

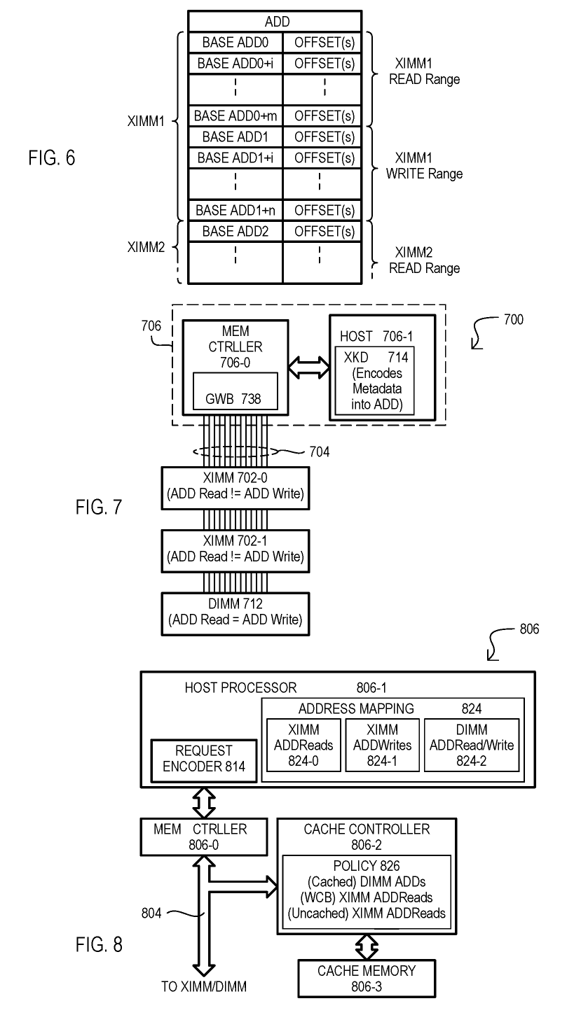

FIG. 6 is a table showing memory mapping according to one particular embodiment. Physical memory addresses can include a base portion (BASE ADDn, where n is an integer) and an offset portion (OFFSET(s)). For one XIMM (XIMM1), all reads will fall within the range starting within addresses starting with base address BASE ADD0, while all write operations to the same XIMM1 will fall within addresses starting with BASE ADD1.

FIG. 7 shows a network appliance 700 according to another embodiment. An appliance 700 can include a control device 706 having a host device 706-1 and memory controller 706-0. A host device can include a driver (XKD) 714. XKD 714 can be a program executed by host device 706-1 which can encode requests into physical addresses, as described herein, or equivalents. A memory controller 706-0 can include a GWB 738 and be connected to memory bus 704.

XIMMs 702-0/1 can be attached to memory bus 704, and can be accessed by read and/or write operations by memory controller 706-0. XIMMs 702-0/1 can have read addresses that are different from write addresses (ADD Read !=ADD Write).

Optionally, an appliance 700 can include a conventional memory device (DIMM) 712 attached to the same memory bus 704 as XIMMs 702-0/1. Conventional memory device 712 can have conventional read/write address mapping, where data written to an address is read back from the same address.

According to some embodiments, host devices (e.g., x86 type processors) of an appliance can utilize processor speculative reads. Therefore, if a XIMM is viewed as a write-combining or cacheable memory by such a processor, the processor may speculate with reads to the XIMMs. As understood from herein, reads to XIMMs are not data accesses, but rather encoded operations, thus speculative reads could be destructive to a XIMM state.

Accordingly, according to some embodiments, in systems having speculative reads, XIMM read address ranges can be mapped as uncached. Because uncached reads can incur latencies, in some embodiments, XIMMs accesses can vary according to data output size. For encoded read operations that result smaller data outputs from the XIMMs (e.g., 64 to 128 bytes), such data can be output in a conventional read fashion. However, for larger data sizes, where possible, such accesses can involve direct memory access (DMA) type transfers (or DMA equivalents of other memory bus types).

In systems according to some embodiments, write caching can be employed. While embodiments can include XIMM write addresses that are uncached (as in the case of read addresses) such an arrangement may be less desirable due to the performance hit incurred, particularly if accesses include burst writes of data to XIMMs. Write-back caching can also yield unsuitable results if implemented with XIMMs. Write caching can result in consecutive writes to the same cache line, resulting in write data from a previous access being overwritten. This can essentially destroy any previous write operation to the XIMM address. Write-through caching can incur extra overhead that is unnecessary, particularly when there may never be reads to addresses that are written (i.e., embodiments when XIMM read addresses are different from their write addresses).

In light of the above, according to some embodiments a XIMM write address range can be mapped as write-combining. Thus, such writes can be stored and combined in some structure (e.g., write combine buffer) and then written in order into the XIMM.

FIG. 8 is a block diagram of a control device 806 that can be included in embodiments. In very particular embodiments, control device 806 can be one implementation of that shown in FIG. 1, 2 or 7 (i.e., 106, 206, 706). A control device 806 can include a host processor 806-1, memory controller 806-0, cache controller 806-2, and a cache memory 806-3. A host processor 806-1 can access an address space having an address mapping 824 that includes physical addresses corresponding to XIMM reads 824-0, XIMM writes 824-1 and conventional memory (e.g., DIMM) read/writes 824-2. Host processor 806-1 can also include a request encoder 814 which can encode requests into memory accesses to XIMM address spaces 824-0/1. According to embodiments, a request encoder 814 can be a driver, logic or combination thereof.

The particular control device 806 shown can also include a cache controller 806-2 connected to memory bus 804. A cache controller 806-2 can have a cache policy 826, which in the embodiment shown, can treat XIMM read addresses a uncached, XIMM write addresses as write combining, and addresses for conventional memories (e.g., DIMMs) as cacheable. A cache memory 806-3 can be connected to the cache controller 806-2. While FIG. 8 shows a lookaside cache, alternate embodiments can include a look through cache.

According to embodiments, an address that accesses a XIMM can be decomposed into a base physical address and an offset (shown as ADD Ext 1, ADD Ext 2 in FIG. 5). Thus, in some embodiments, each XIMM can have a base physical address which represents the memory range hosted by the XIMM as viewed by a host and/or memory controller. In such embodiments, a base physical address can be used to select a XIMM, thus the access semantics can be encoded in the offset bits of the address. Accordingly, according to some embodiments, a base address can identify a XIMM to be accessed, and the remaining offset bits can indicate operations that occur in the XIMM. Thus, it is understood that an offset between base addresses will be large enough to accommodate the entire encoded address map. The size of the address map encoded in the offset can be considered a memory “size” of the XIMM, which is the size of the memory range that will be mapped by request encoder (e.g., XKD kernel driver) for the memory interface to each XIMM.

As noted above, for systems with memory controllers having a GWB or similar type of caching, XIMMs can have separate read and write address ranges. Furthermore, read address ranges can be mapped as uncached, in order to ensure that no speculative reads are made to a XIMM. Writes can be mapped as write-combining in order to ensure that writes always get performed when they are issued, and with suitable performance (see FIGS. 6-8, for example). Thus, a XIMM can appear in an appliance like a memory device with separate read and write address ranges, with each separate range having separate mapping policies. A total size of a XIMM memory device can thus include a sum of both its read and write address ranges.

According to embodiments, address ranges for XIMMs can be chosen to be a multiple of the largest page size that can be mapped (e.g., either 2 or 4 Mbytes). Since these page table mappings may not be backed up by RAM pages, but are in fact a device mapping, a host kernel can be configured for as many large pages as it takes to map a maximum number of XIMMs. As but one very particular example, there can be 32 to 64 large pages/XIMM, given that the read and write address ranges must both have their own mappings.

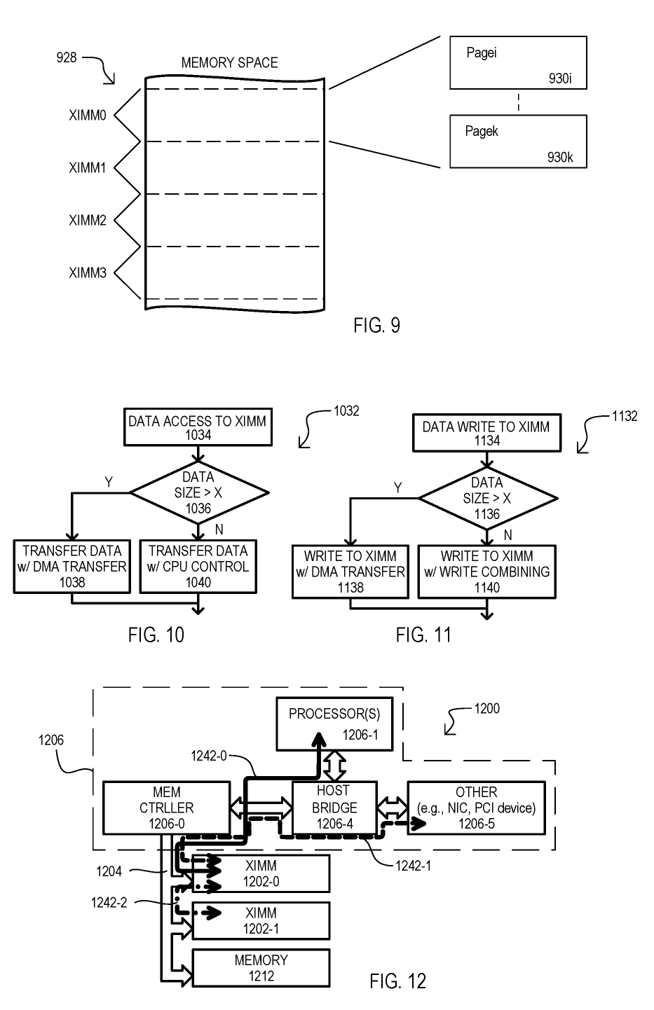

FIG. 9 is a diagram showing memory mapping according to an embodiment. A memory space 928 of an appliance can include pages, with address ranges for XIMMs mapped to groups of such pages. For example, address ranges for XIMM0 can be mapped from page 930i (Pagei) to page 930k (Pagek).

As noted above, according to some embodiments data transfers between XIMMs and a data source/sink can vary according to size. FIG. 10 is a flow diagram showing a data transfer processes that can be included embodiments. A data transfer process 1032 can include determining that a XIMM data access is to occur (1034). This can include determining if a data write or data read is to occur to a XIMM (note, again this is not a conventional write operation or read operation). If the size of a data transfer is over a certain size (Y from 1036), data can be transferred to/from a XIMM with a DMA (or equivalent) type of data transfer 1038. If data is not over a certain size (N from 1036), data can be transferred to/from a XIMM with a conventional data transfer operation 1040 (e.g., CPU controlled writing). It is noted that a size used in box 1036 can be different between read and write operations.

According to some embodiments, a type of write operation to a XIMM can vary according to write data size. FIG. 11 shows one particular example of such an embodiment. FIG. 11 is a flow diagram showing a data transfer process 1132 according to another embodiment. A data transfer process 1132 can include determining that a write to a XIMM is to occur (1134). If the size of the write data transfer is over a certain size (Y from 1136), data can be written to a XIMM with a DMA (or equivalent) type of data transfer 1138. If data is not over a certain size (N from 1136), data can be written to a XIMM with a particular type of write operation, which in the embodiment shown is a write combining type write operation 1140.

FIG. 12 is a block schematic diagram showing possible data transfer operations in a network appliance 1200 according to embodiments. Appliance 1200 can include a control device 1206 that includes a memory controller 1206-0, processor(s) 1206-1, host bridge 1206-4 and one or more other bus attached devices 1206-5. XIMMs 1202-0/1 can be connected to memory controller 1206-0 by

Possible data transfer paths to/from XIMMs 1202-0/1 can include a path 1262-0 between processor(s) 1206-1 and a XIMM 1202-0, a path 1242-1 between a bus attached (e.g., PCI) device 1206-5 and a XIMM 1202-0, and a path 1242-2 between one XIMM 1202-0 and another XIMM 1202-1. In some embodiments, such data transfers (1242-0 to -2) can occur through DMA or equivalent type transfers.

In particular embodiments, an appliance can include host-XIMM interface that is compatible with DRAM type accesses (e.g., DIMM accesses). In such embodiments, accesses to the XIMM can be via row address strobe (RAS) and then (in some cases) a column address strobe (CAS) phase of a memory access. As understood from embodiments herein, internally to the XIMM, there is no row and column selection of memory cells as would occur in a conventional memory device. Rather, the physical address provided in the RAS and (optionally CAS) phases can inform circuits within the XIMM (e.g., an arbiter 208 of FIG. 2) which resource of the XIMM is the target of the operation and identify which device is mastering the transaction (e.g., host device, NIC, or PCI device). While embodiments can utilize any suitable memory interface, as noted herein, particular embodiments can include operations in accordance with a DDR interface.

As noted herein, a XIMM can include an arbiter for handling accesses over a memory bus. In embodiments where address multiplexing is used (i.e., a row address is followed by a column address), an interface/protocol can encode certain operations along address boundaries of the most significant portion of a multiplexed address (most often the row address). Further such encoding can vary according to access type.

In particular embodiments, how an address is encoded can vary according to the access type. In an embodiment with row and column addresses, an arbiter within a XIMM can be capable of locating the data being accessed for an operation and can return data in a subsequent CAS phase of the access. In such an embodiment, in read accesses, a physical address presented in the RAS phase of the access identifies the data for the arbiter so that the arbiter has a chance to respond in time during the CAS phase. In a very particular embodiment, read addresses for XIMMs are aligned on a row address boundaries (e.g., 4K boundary assuming a 12-bit row address).

While embodiments can include address encoding limitations in read accesses to ensure rapid response, such a limitation may not be included in write accesses, since no data will be returned. For writes, an interface may have a write address (e.g., row address, or both row and column address) completely determine a target within the XIMM to which the write data are sent.

In some appliances, a control device can include a memory controller that utilizes error correction and/or detection (ECC). According to some embodiments, in such an appliance ECC can be disabled, at least for accesses to XIMMs. However, in other embodiments, XIMMs can be include the ECC algorithm utilized by the memory controller, and generate the appropriate ECC bits for data transfers.

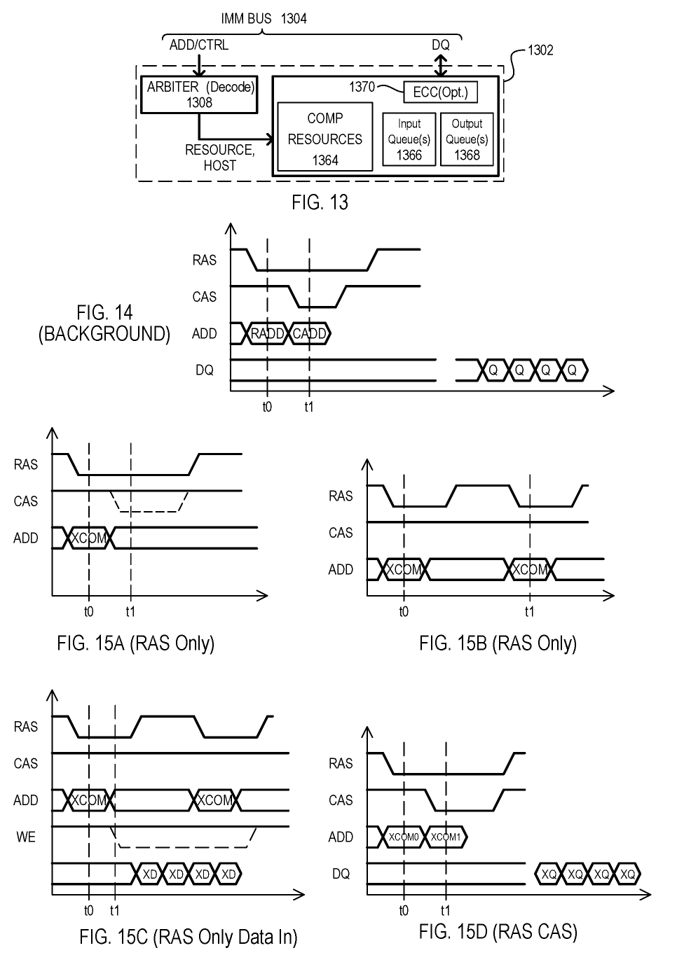

FIG. 13 shows a XIMM 1302 according to an embodiment. A XIMM 1302 can interface with a bus 1304, which in the embodiment shown can be an in-line module compatible bus. Bus 1304 can include address and control inputs (ADD/CTRL) as well as data inputs/outputs (DQ). An arbiter (ARBITER) 1308 can decode address and/or control information to derive transaction information, such as a targeted resource, as well as a host (controlling device) for the transaction. XIMM 1302 can include one or more resources, including computing resources (COMP RESOURCES 1344) (e.g., processor cores), one or more input queues 1346 and one or more output queues 1348. Optionally, a XIMM 1302 can include an ECC function 1350 to generate appropriate ECC bits for data transmitted over DQ.

FIG. 14 shows a conventional memory access over a DDR interface. FIG. 14 shows a conventional RAM read access. A row address (RADD) is applied with a RAS signal (active low), and a column address (CADD) is applied with a CAS signal (active low). It is understood that t0 and t1 can be synchronous with a timing clock (not shown). According to a read latency, output data (Q) can be provided in a data 10 (DQ).

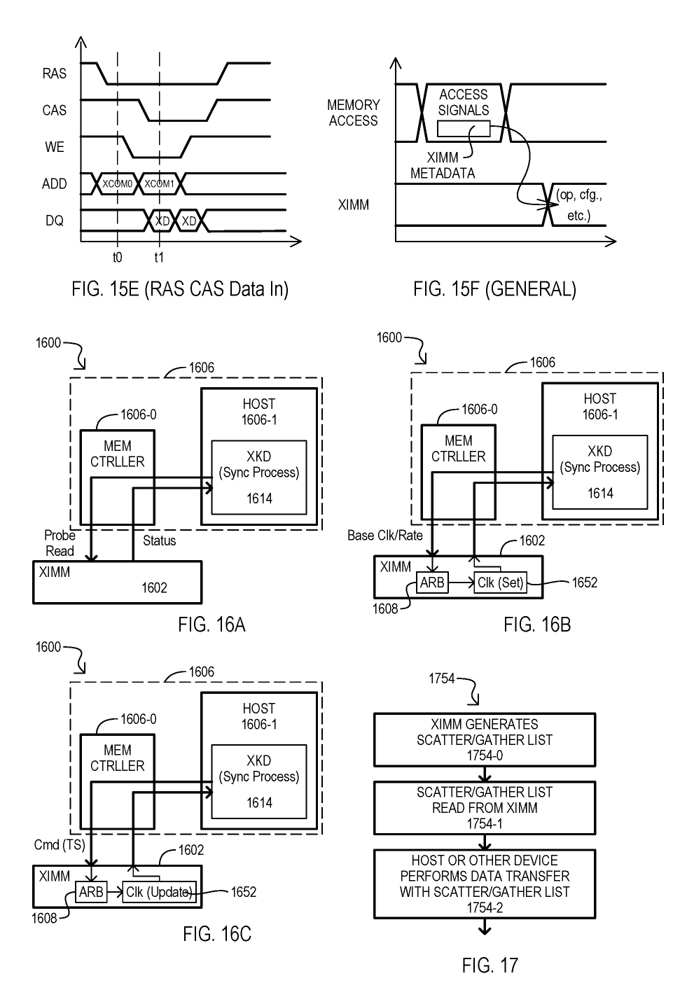

FIG. 15A shows a XIMM access over a DDR interface according to one embodiment. FIG. 15A shows a “RAS” only access. In such an access, unlike a conventional access, operations can occur in response to address data (XCOM) available on a RAS strobe. In some embodiments, additional address data can be presented in a CAS strobe to further define an operation. However, in other embodiments, all operations for a XIMM can be dictated within the RAS strobe.

FIG. 15B shows XIMM accesses over a DDR interface according to another embodiment. FIG. 15B shows consecutive “RAS” only access. In such accesses, operations within a XIMM or XIMMs can be initiated by RAS strobes only.

FIG. 15C shows a XIMM access over a DDR interface according to a further embodiment. FIG. 15C shows a RAS only access in which data are provided with the address. It is understood that the timing of the write data can vary according to system configuration and/or memory bus protocol.

FIG. 15D shows a XIMM access over a DDR interface according to another embodiment. FIG. 15D shows a “RAS CAS” read type access. In such an access, operations can occur like a conventional memory access, supplying a first portion XCOM0 on a RAS strobe and a second portion XCOM1 on a CAS strobe. Together XCOM0/XCOM1 can define a transaction to a XIMM.

FIG. 15E shows a XIMM access over a DDR interface according to another embodiment. FIG. 15E shows a “RAS CAS” write type access. In such an access, operations can occur like a conventional memory access, supplying a first portion XCOM0 on a RAS strobe and a second portion XCOM1 on a CAS strobe. As in the case of FIG. 15C, timing of the write data can vary according to system configuration.

It is noted that FIGS. 15A to 15E show but one very particular example of XIMM access operations on a DRAM DDR compatible bus. However, embodiments can include any suitable memory device bus/interfaces including but not limited hybrid memory cube (HMC) and RDRAM promulgated by Rambus Incorporated of Sunnyvale, Calif., U.S.A., to name just two.

FIG. 15F shows XIMM access operations according to a more general embodiment. Memory access signals (ACCESS SIGNALS) can be generated in a memory interface/access structure (MEMORY ACCESS). Such signals can be compatible with signals to access one or more memory devices. However, within such access signals can be XIMM metadata. Received XIMM metadata can be used by a XIMM to perform any of the various XIMM functions described herein, or equivalents.

In some embodiments, all reads of different resources in a XIMM can fall on a separate range (e.g., 4K) of the address. An address map can divide the address offset into three (or more four) fields: Class bits; Selector bits; Additional address metadata; and optionally (Read/write bit). Such fields can have the following features:

Class bits: can be used to define the type of transaction encoded in the address

Selector bits: can be used to select a FIFO or a processor (e.g., ARM) within a particular class, or perhaps specify different control operations.

Additional address metadata: can be used to further define if a particular class of transaction involving the compute elements.

Read/write: One (or more) bits can be used to determine whether the access applies to a read or a write. This can be a highest bit of the physical address offset for the XIMM.

Furthermore, according to embodiments, an address map can be large enough in range to accommodate transfers to/from any given processor/resource. In some embodiments, such a range can be at least 256 Kbytes, more particularly 512 Kbytes.

Input formats according to very particular embodiments will now be described. The description below points out an arrangement in which three address classes can be encoded in the upper bits of the physical address, (optionally allowing for a R/W bit and) for a static 512K address range for each processor/resource. The basic address format for a XIMM according to this particular embodiment, is shown in Table 1:

TABLE 1

| Base Physical | | | | |
|---|---|---|---|---|
| Address | R/W | Class | Target/Cntrl Select, etc | XXX |
| 63 . . . 27 | 26 | 25 . . . 24 | 23 . . . 12 | 11 . . . 0 |

In such an address mapping like that of Table 1, a XIMM can have a mapping of up to 128 Mbytes in size, and each read/write address range can be 64 Mbytes in size. There can be 16 Mbytes/32=512 Kbytes available for data transfer to/from a processor/resource. There can be an additional 4 Mbytes available for large transfers to/from only one processor/resource at a time. In the format above, bits 25, 24 of the address offset can determine the address class. An address class determine the handling and format of the access. In one embodiment, there can be three address classes: Control, APP and DMA.

Control: There can be two types of Control inputs—Global Control and Local Control. Control inputs can be used for various control functions for a XIMM, including but not limited to: clock synchronization between a request encoder (e.g., XKD) and an Arbiter of a XIMM; metadata reads; and assigning physical address ranges to a compute element, as but a few examples. Control inputs may access FIFOs with control data in them, or may result in the Arbiter updating its internal state.

APP: Accesses which are of the APP class can target a processor (ARM) core (i.e., computing element) and involve data transfer into/out of a compute element.

DMA: This type of access can be performed by a DMA device. Optionally, whether it is a read or write can be specified in the R/W bit in the address for the access.

Each of the class bits can determine a different address format. An arbiter within the XIMM can interpret the address based upon the class and whether the access is a read or write. Examples of particular address formats are discussed below.

Possible address formats for the different classes are as follows:

One particular example of a Control Address Format according to an embodiment is shown in Table 2.

TABLE 2

| Base Physical | | | | Target/Cntrl | |
|---|---|---|---|---|---|
| Address | R/W | Class | Global | Select | XXX |
| 63 . . . 27 | 26 | 25 . . . 24 | 23 | 22 . . . 12 | 11 . . . 0 |

Class bits 00b: This is the address format for Control Class inputs. Bits 25 and 24 can be 0. Bit 23 can be used to specify where the Control input is Global or Local. Global control inputs can be for an arbiter of a XIMM, whereas a local control input can be for control operations of a particular processor/resource within the XIMM (e.g., computing element, ARM core, etc.). Control bits 22 . . . 12 are available for a Control type and/or to specify a target resource. An initial data word of 64 bits can be followed by “payload” data words, which can provide for additional decoding or control values.

In a particular embodiment, bit 23=1 can specify Global Control. Field “XXX” can be zero for reads (i.e., the lower 12 bits), but these 12 bits can hold address metadata for writes, which may be used for Local Control inputs. Since Control inputs are not data intensive, not all of the Target/Cntrl Select bits may be used. A 4K max inputs size can be one limit for Control inputs. Thus, when the Global bit is 0 (Control inputs destined for an ARM), only the Select bits 16 . . . 12 can be set.

One particular example of an Application (APP) Address Format is shown in Table 3. In the example shown, for APP class inputs, bit 25=0, bit 24=1. This address format can have the following form (RW may not be included):

TABLE 3

| Base Physical | | | | | |
|---|---|---|---|---|---|
| Address | R/W | Class | Target Select | Must be 0 | XXX |
| 63 . . . 27 | 26 | 25 . . . 24 | 23 . . . 19 | 18 . . . 12 | 11 . . . 0 |

Field “XXX” may encode address metadata on writes but can be all be 0's on reads.

It is understood that a largest size of transfer that can with a fixed format scheme like that shown can be 512K. Therefore, in a particular embodiment, bits 18 . . . 12 can be 0 so that the Target Select bits are aligned on a 512K boundary. The Target Select bits can allow for a 512K byte range for every resource of the XIMM, with an additional 4 Mbytes that can be used for a large transfer.

One particular example of a DMA Address Format is shown in Table 4. For a DMA address class bits can be 10b. This format can be used for a DMA operation to or from a XIMM. In some embodiments, control signals can indicate read/write. Other embodiments may include bit 26 to determine read/write.

TABLE 4

| Base Physical | | | | | |
|---|---|---|---|---|---|
| Address | R/W | Class | Target Select | All 0's | XXX |
| 63 . . . 27 | 26 | 25 . . . 24 | 23 . . . 19 | 18 . . . 12 | 11 . . . 0 |

In embodiments in which a XIMM can be accessed over a DDR channel, a XIMM can be a slave device. Therefore, when the XIMM Arbiter has an output queued up for the host or any other destination, it does not master the DDR transaction and send the data. Instead, such output data is read by the host or a DMA device. According to embodiments, a host and the XIMM/Arbiter have coordinated schedules, thus the host (or other destination) knows the rate of arrival/generation of at a XIMM and can time its read accordingly.

Embodiments can include other metadata that can be communicated in read from a XIMM as part of a payload. This metadata may not be part of the address and can be generated by an Arbiter on the XIMM. The purpose of Arbiter metadata in a request encoder (e.g., XKD)-Arbiter interface can be to communicate scheduling information so that the request encoder can schedule reads in a timely enough manner in order to minimize the latency of XIMM processing, as well as avoiding back-pressure in the XIMMs.

Therefore, in some embodiments, a request encoder-Arbiter having a DDR interface can operate as follows. A request encoder can encode metadata in the address of DDR inputs sent to the Arbiter, as discussed above already. Clock synchronization and adjustment protocols can maintain a clock-synchronous domain of a request encoder instance and its DDR-network of XIMMs. All XIMMs in the network can maintain a clock that is kept in sync with the local request encoder clock. A request encoder can timestamp of inputs it sends to the Arbiter. When data are read from the Arbiter by the request encoder (e.g., host), the XIMM Arbiter can write metadata with the data, communicating information about what data is available to read next. Still further, a request encoder can issue control messages to an Arbiter to query its output queue(s) and to acquire other relevant state information.

According to embodiments, XIMMs in a same memory domain can operate in a same clock domain. XIMMs of a same memory domain can be those that are directly accessible by a host device or other request encoder (e.g., an instance of an XKD and those XIMMs that are directly accessible via memory bus accesses). Hereinafter, reference to an XKD is understood to be any suitable request encoder.

A common clock domain can enable the organization of scheduled accesses to keep data moving through the XIMMs. According to some embodiments, an XKD does not have to poll for output or output metadata on its own host schedule, as XIMM operations can be synchronized for deterministic operations on data. An Arbiter can communicate at time intervals when data will be ready for reading, or at an interval of data arrival rate, as the Arbiter and XKD can have synchronized clock values.

Thus, according to embodiments, each Arbiter of a XIMM can implement a clock that is kept in sync with an XKD. When a XKD discovers a XIMM through a startup operation (e.g., SMBIOS operation) or through a probe read, the XKD can seek to sync up the Arbiter clock with its own clock, so that subsequent communication is deterministic. From then on, the Arbiter will implement a simple clock synchronization protocol to maintain clock synchronization, if needed. Such synchronization may not be needed, or may be needed very infrequently according to the type of clock circuits employed on the XIMM.

According to very particular embodiments, an Arbiter clock can operate with fine granularity (e.g., nanosecond granularity) for accurate timestamping. However, for operations with a host, an Arbiter can sync up with a coarser granularity (e.g., microsecond granularity). In some embodiments, a clock drift of up to one μsec can be allowed.

Clock synchronization can be implemented in any suitable way. As but one example, periodic clock values can be transmitted from one device to another (e.g., controller to XIMM or vice versa). In addition or alternatively, circuits can be used for clock synchronization, including but not limited to PLL, DLL circuits operating on an input clock signal and/or a clock recovered from a data stream.

FIGS. 16A to 16C shows a clock synchronization method according to one very particular embodiment. This method should not be construed as limiting. Referring to FIG. 16A, a network appliance 1600 can include a control device 1606 having a memory controller 1606-0 and a host 1606-1 with a request encoder (XKD) 1614. XKD 1614 can discover a XIMM 1602 through a system management BIOS operation or through a probe read.

Referring to FIG. 16B, XKD 1614 can send to the arbiter 1608 of the XIMM 1602 a Global Control type ClockSync input, which will supply a base clock and the rate that the clock is running (e.g., frequency). Arbiter 1608 can use the clock base it receives in the Control ClockSync input and can start its clock circuit 1652.

Referring to FIG. 16C, for certain inputs (e.g., Global Control input) XKD 1614 can send to the arbiter 1608 a clock timestamp. Such a timestamp can be encoded into address data. A timestamp can be included in every input to a XIMM 1602 or can be a value that is periodically sent to the XIMM 1602. According to some embodiments, a timestamp can be taken as late as possible by an XKD 1614, in order to reduce scheduler-induced jitter on the host 1606-1. For every timestamp received, an arbiter 1608 can check its clock and make adjustments.

According to some embodiments, whenever an arbiter responds to a read request from the host, where the read is not a DMA read, an arbiter can include the following metadata: (1) a timestamp of the input when it arrived in storage circuits of the arbiter (e.g., a FIFO of the arbiter); (2) information for data queued up from a XIMM, (e.g., source, destination, length). The arbiter metadata can be modified to accommodate a bulk interface. A bulk interface can handle up to some maximum number of inputs, with source and length for each input queued. Such a configuration can allow bulk reads of arbiter output and subsequent queuing in memory (e.g., RAM) of a XIMM output so that the number of XKD transactions can be reduced.

According to some embodiments, an appliance can issue various control messages from an XKD to an arbiter of a XIMM. Control messages are described below, and can be a subset of the control messages that a request encoder can send to an arbiter according to very particular embodiments. The control messages described here can assist in the synchronization between the XKD and the Arbiter.

Probe read: This can be read operations issued that are used for XIMM discovery. An Arbiter of any XIMM can return the data synchronously for the reads. The data returned can be constant and identify the device residing on the bus as a XIMM. In a particular embodiment, such a response can be 64 bytes and includes XIMM model number, XIMM version, operating system (e.g., Linux version running on ARM cores), and other configuration data.

Output snapshot: This can be a read operation to XIMM to get information on any Arbiter output queues, such as the lengths of each, along with any state that is of interest for a queue. Since these reads are for the Arbiter, in a format like that of Table 1 a global bit can be set. In a very particular embodiment bit 21 can be set.

Clock sync: This operation can be used to set the clock base for the Arbiter clock. There can be a clock value in the data (e.g., 64 bit), and the rest of the input can be padded with 0's. In a format like that of Table 1 a global bit can be set, and in a very particular embodiment bit 23 can be set. It is noted that a XKD can send a ClockSync input to the Arbiter if a read from a XIMM shows the Arbiter clock to be too far out of sync (assuming the read yields timestamp or other synchronization data).

Embodiments herein have described XIMM address classes and formats used in communication with a XIMM. While some semantics are encoded in the address, for some transactions it may not be possible to encode all semantics, nor to include parity on all inputs, or to encode a timestamp, etc. This section discusses the input formats that can be used at the beginning of the data that is sent along with the address of the input. The description shows Control and APP class inputs and are assumed to be DDR inputs, thus there can be data encoded in the address, and the input header can be sent at the head of the data according to the formats specified.

The below examples correspond to a format like that shown in Table 1.

### Global Control Inputs:

### Address:

Class=Control=00b, bit 23=1
Bits 22 . . . 12: Control select or 0 (Control select in address might be redundant since Control values can be set in the input header)
Address metadata: all 0

### Data:

Decode=GLOBAL_CNTL
Control values:
   Reads: Probe, Get Monitor, Output Probe
   Writes: Clock Sync. Set Large Transfer Window Destination, Set Xockets Mapping, Set Monitor
      The input format can differ for reads and writes. Note that in the embodiment shown, header decode can be constant and set to GLOBAL_CNTL, because the address bits for Control Select specify the input type. In other embodiments, a format can differ, if the number of global input types exceeds the number of Control Select bits.

### Reads:

Data can be returned synchronously for Probe Reads and can identify the memory device as a XIMM.
Address: (XIMM base addr)+(class bits=00b)+(bit 23=1)+(Control select=bit setting for XIMM_PROBE). Table 5 shows an example of returned data.

TABLE 5

| | | |
|---|---|---|
| Parity | 8 bits | Parity calculated off of this control message |
| Decode | 8 | GLOBAL_CNTL |
| Timestamp | 64 | Arbiter timestamp set when message posted, 0 on |
| | | first probe since Arbiter clock not set yet |
| Synchro- | 64 | Information and flags on the current output queue |
| nization | | state |
| Payload | M | Information on this XIMM: rev id, firmware |
| | | revision, ARM OS rev, etc: M is the payload |
| | | and padding to round this input to 64 bytes |

This next input is the response to an OUTPUT_PROBE:
Address: (XIMM base addr)+(class bits=00b)+(bit 23=1)+(Control select=bit setting for APP_SCHEDULING)
This format assumes output from a single source. Alternate embodiments can be modified to accommodate bulk reads, so that one read can absorb multiple inputs, with an XKD buffering the input data. Table 6 shows an example of returned data.

TABLE 6

| | | |
|---|---|---|
| Parity | 8 | Parity calculated off the expected socket and |
| | | ReadTime to verify data |
| Decode | 8 | GLOBAL_CNTL |
| Source | 8 | The next Xockets ID that will be read (i.e., |
| | | the next read will yield output from the specified |
| | | Xockets ID) |
| ReadTimeN | 8 | The time that the next read should take (should |
| | | have taken) place. This can be expressed as a usec |
| | | interval based off of the Arbiter's synchro- |
| | | nized clock, where any clock adjustments were made |
| | | based on the host timestamp in the Output Probe. |
| LengthN | N | The number of bytes to read |

### Writes:

The following is the CLOCK_SYNC input, sent by a XKD when it first identifies a XIMM or when it deems the XIMM as being too out of sync with the XKD.
Address: (XIMM base addr)+(class bits=00b)+(bit 23=1)+(Control select=bit setting for CLOCK_SYNC). Table 7 shows an example.

TABLE 7

| | | |
|---|---|---|
| Parity | 8 bits | Parity calculated for this control message |
| Decode | 8 | GLOBAL_CNTL |
| Timestamp | 64 | A timestamp or tag for when this message was |
| | | posted |
| Control | 16 | The control action to take (Clock synchronization) |
| Monitoring | 16 | Local state that the host would like presented after |
| | | action |

This next input can be issued after the XIMM has indicated in its metadata that no output is queued up. When a XKD encounters that, it can start polling an Arbiter for an output (in some embodiments, this can be at predetermined intervals).
Address: (XIMM base addr)+(class bits=00b)+(bit 23=1)+(Control select=bit setting for OUTPUT_PROBE). Table 8 shows an example.

TABLE 8

| | | |
|---|---|---|
| Parity | 8 bits | Parity calculated for this control message |
| Decode | 8 | GLOBAL_CNTL |
| Timestamp | 64 | A timestamp or tag for when this message was |
| | | posted |

The following input can be sent by an XKD to associate a Xocket ID with a compute element of a XIMM (e.g., an ARM core). From then on, the Xocket ID can be used in Target Select bits of the address for Local Control or APP inputs.
Address: (XIMM base addr)+(class bits=00b)+(bit 23=1)+(Control select=bit setting for SET_XOCKET_MAPPING). Table 9 shows an example.

TABLE 9

| Parity | 8 bits | Parity calculated for this control message |
|---|---|---|
| Decode | 8 | GLOBAL_CNTL |
| Timestamp | 64 | A timestamp for when this message was posted |
| Xocket ID | 8 | Xocket ID number (may not be 1:1 with ARM core |
| | | number) |
| Destination | 8 | ARM ID |

The following input can be used to set a Large Transfer (Xfer) Window mapping. In the example shown, it is presumed that no acknowledgement is required. That is, once this input is sent, the next input using the Large Xfer Window should go to the latest destination.
Address: (XIMM base addr)+(class bits=00b)+(bit 23=1)+(Control select=bit setting for SET_LARGE_XFER_WNDW). Table 10 shows an example.

TABLE 10

| | | |
|---|---|---|
| Parity | 8 bits | Parity calculated for this control message |
| Decode | 8 | GLOBAL_CNTL |
| Timestamp | 64 | A timestamp for when this message was posted |
| Xocket ID | 8 | Xocket ID number (may not be 1:1 with ARM core |
| | | number) |

### Local Control Inputs:

### Address:

Class=Control=00b, bit 23=0
Bits 22 . . . 12: Target select (Destination Xocket ID or ARM ID)
Address metadata=Xocket Id (writes only)

### Data:

Decode=CNTL_TYPE
Control values:
   Can specify an executable to load, download information, etc. These Control values can help to specify the environment or operation of XIMM resources (e.g., ARM cores). Note that, unlike Global Control, the input header can be included for the parsing and handling of the input. An address cannot specify the control type, since only the Arbiter sees the address.
      An example is shown in Table 11.

TABLE 11

| | | |
|---|---|---|
| Parity | 8 bits | Parity calculated off of this control message |
| Decode | 8 | A single byte distinguishing the control message |
| | | type |
| Control | 16 | The control action to take specific to the control |
| | | channel and decode |
| Monitoring | 16 | Local state that the host would like presented after |
| | | action(async) |

### Application Inputs

### Address:

Class=APP=01b
Bits 23 . . . 19: Target select (Destination Xocket ID or ARM ID)
Address metadata=Socket Number or Application ID running on a compute element (e.g., ARM core) associated with the Xocket ID in the Target select bits of the address (writes only)

### Data:

Writes:

Below is an example of an input format for writes to a socket/application on a computing resource (e.g., ARM core). Note that for these types of writes, all writes to the same socket or to the same physical address can be of this message until M/8 bytes of the payload are received, and the remaining bytes to a 64B boundary is zero-filled. If a parity or a zero fill is indicated, errors can be posted in the monitoring status (see Reads). That is, writes may be interleaved if the different writes are targeting different destinations within the XIMM. The host drivers can make sure that there is only one write at a time targeting a given computing resource. Table 12 shows an example.

TABLE 12

| | | |
|---|---|---|
| Parity | 8 bits | Parity calculated over the entire payload |
| Decode | 8 bits | APP_DATA |
| Length | 24 bits | Number of bytes of the data to send to the control |
| | | processor |
| Payload | M | Payload for the socket: actual payload + padding to |
| | | round to 64 byte boundary |

Reads:

Below in Tables 13 and 14 is a scatter transmit example. Class=APP; Decode=SCATTER_TX.

TABLE 13

| | | |
|---|---|---|
| Parity | 8 bits | Parity calculated over the entire payload |
| Decode | 8 bits | APP_DATA |
| SourceN | 64 bits | Source address for the DMA |
| P | M | Payload for the socket: actual payload + padding |
| | | to round to 64 byte boundary |

TABLE 14

| | | |
|---|---|---|
| Parity | 8 | Parity calculated off the expected socket and |
| | | ReadTime to verify data |
| Decode | 8 | A single byte distinguishing the decode type |
| SourceN | 6 | The dynamically allocated XIMM source address (SA) |
| | | that will be associated with the DMA |
| ReadTimeN | 8 | The time that the scatter should take (should have |
| | | taken) place |
| LengthN | | The number of bytes to read in the DMA |
| DegreeN | 8 | Number of destinations to scatter to |
| DestN | | Destination addresses |

Below in Table 15 a gather receive example is shown. Class=APP, Decode=GATHER_RX.

TABLE 14

| | | |
|---|---|---|
| Parity | | Parity calculated off the expected socket and |
| | | ReadTime to verify data |
| Decode | | A single byte distinguishing the decode type |
| DestN | 8 | The dynamically allocated XIMM (destination address) |
| | | DA that will be associated with the DMA |
| ReadTimeN | 8 | The time that the gather should take (should have |
| | | taken) place |
| LengthN | | The number of bytes to read in the DMA |
| DegreeN | 8 | Number of sources to gather from |
| SourceN | | Source addresses |

FIG. 17 shows one example of scatter/gather operations 1754-0 that can occur in a XIMM according to embodiments. In response to a XKD request, a XIMM can generate a scatter or gather list 1754-0. This can occur on the XIMM with data stored on the XIMM. At a predetermined time XKD (or other device) can read the scatter/gather list from the XIMM 1754-1. It is understood that this is not a read from a memory device, but rather an output buffer in the XIMM. The XKD or other device can then perform a data transfer to using the scatter gather list 1754-2.

While embodiments can include network appliances, including those with XIMMs, other embodiments can include computing infrastructures that employ such appliances. Such infrastructures can run different distributed frameworks for “big data” processing, as but one limited example. Such a computing infrastructure can host multiple diverse, large distributed frameworks with as little change as compared to conventional systems.

A computing infrastructure according to particular embodiments can be conceptualized as including a cluster infrastructure and a computational infrastructure. A cluster infrastructure can manage and configure computing clusters, including but not limited to cluster resource allocation, distributed consensus/agreement, failure detection, replication, resource location, and data exchange methods.

A computational infrastructure according to particular embodiments can be directed to unstructured data, and can include two classes of applications: batch and streaming. Both classes of applications can apply the same types of transformations to the data sets. However, the applications can differ in the size of the data sets (the batched applications, like Hadoop, can typically be used for very large data sets). However, but the data transformations can be similar, since the data is fundamentally unstructured and that can determine the nature of the operations on the data.

According to embodiments, computing infrastructures can include network appliances (referred to herein as appliances), as described herein, or equivalents. Such appliances can improve the processing of data by the infrastructures. Such an appliance can be integrated into server systems. In particular embodiments, an appliance can be placed within the same rack or alternatively, a different rack than a corresponding server.

A computing infrastructure can accommodate different frameworks with little porting effort and ease of configuration, as compared to conventional systems. According to embodiments, allocation and use of resources for a framework can be transparent to a user.

According to embodiments, a computing infrastructure can include cluster management to enable the integration of appliances into a system having other components.

Cluster infrastructures according to embodiments will now be described. According to embodiments, applications hosted by a computing system can include a cluster manager. As but one particular example, Mesos can be used in the cluster infrastructure. A distributed computation application can be built on the cluster manager (such as Storm, Spark, Hadoop), that can utilize unique clusters (referred to herein as Xockets clusters) based on computing elements of appliances deployed in the computing system. A cluster manager can encapsulate the semantics of different frameworks to enable the configuration of different frameworks. Xockets clusters can be divided along framework lines.

A cluster manager can include extensions to accommodate Xockets clusters. According to embodiments, resources provided by Xockets clusters can be described in terms of computational elements (CEs). A CE can correspond to an elements within an appliance, and can include any of: processor core(s), memory, programmable logic, or even predetermined fixed logic functions. In one very particular embodiment, a computational element can include two ARM cores, a fixed amount of shared synchronous dynamic RAM (SDRAM), and one programmable logic unit. As will be described in more detail below, in some embodiments, a majority if not all of the computing elements can be formed on XIMMs, or equivalent devices, of the appliance. In some embodiments, computational elements can extend beyond memory bus mounted resources, and can include other elements on or accessible via the appliance, such as a host processor (e.g., x86 processor) of the appliance and some amount RAM. The latter resources reflect how appliance elements can cooperate with XIMM elements in a system according to embodiment.

The above description of XIMM resources is in contrast to conventional server approaches, which may allocate resources in terms of processors or Gbytes of RAM, typical metrics of conventional server nodes.

According to embodiments, allocation of Xockets clusters can vary according to the particular framework.

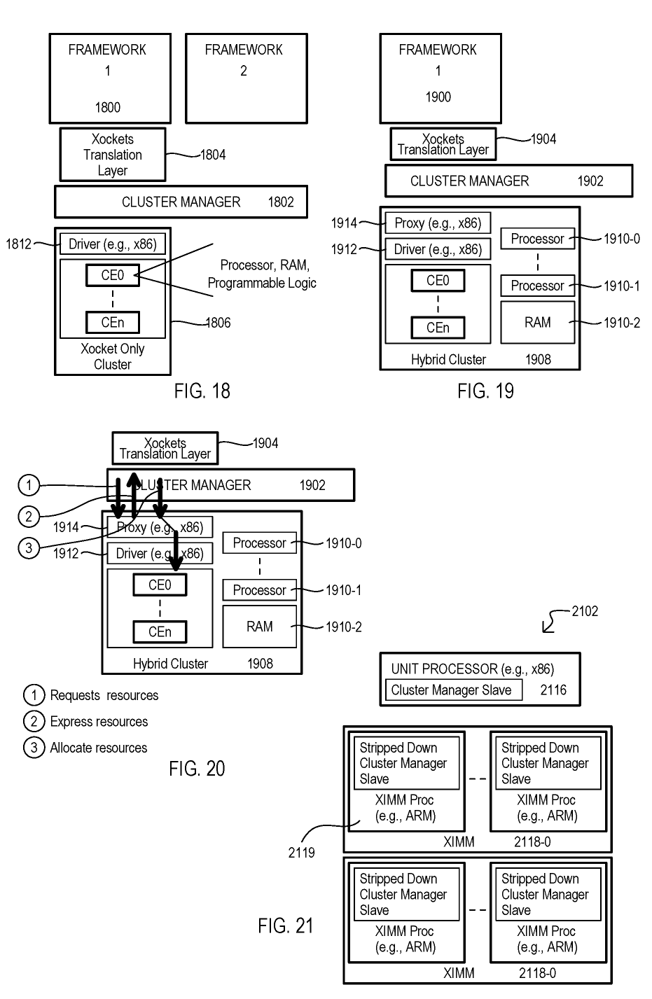

FIG. 18 shows a framework 1800 according to an embodiment that can use resources of appliances (i.e., Xockets clusters). A framework scheduler can run on the cluster manager master 1802 (e.g., Mesos Master) of the cluster. A Xockets translation layer 1804 can run on a host that will sit below the framework 1800 and above the cluster manager 1802. Resource allocations made in the framework calls into the cluster manager can pass through the Xockets translation layer 1804.

A Xockets translation layer 1804 can translate framework calls into requests relevant for a Xockets cluster 1806. A Xockets translation layer 1804 can be relevant to a particular framework and its computational infrastructure. As will be described further below, a Xockets computational infrastructure can be particular to each distributed framework being hosted, and so the particulars of a framework's resource requirements will be understood and stored with the corresponding Xockets translation layer (1804). As but one very particular example, a Spark transformation on a Dstream that is performing a countByWindow could require one computational element, whereas a groupByKeyAndWindow might require two computational elements, an x86 helper process and some amount of RAM depending upon window size. For each Xockets cluster there can be a resource list associated with the different transformations associated with a framework. Such a resource list is derived from the computational infrastructure of the hosted framework.

A Xockets cluster 1806 can include various computing elements CE0 to CEn, which can take the form of any of the various circuits described herein, or equivalents (i.e., processor cores, programmable logic, memory, and combinations thereof). In the particular implementation shown, a Xockets cluster 1806 can also include a host processor, which can be resident on the appliance housing the XIMMs which contain the computing elements (CE0 to CEn). Computing elements (CE0 to CEn) can be accessed by XKD 1812.

In other embodiments, a framework can run on one or more appliances and one or more regular servers clusters (i.e., a hybrid cluster). Such an arrangement is shown in FIG. 19. FIG. 19 includes items like those of FIG. 18, and such like items are referred to with the same reference characters but with the leading digits being “19” instead of “18”.

Hybrid cluster 1908 can include conventional cluster elements such as processors 1910-0/1 and RAM 1910-2. In the embodiment shown, a proxy layer 1914 can run above XKD and can communicate with the cluster manager 1902 master. In one very particular example of a hybrid cluster arrangement, an appliance can reside under a top-of-the-rack (TOR) switch and can be part of a cluster that includes conventional servers from the rest of the rack, as well as even more racks, which can also contain one or more Appliances. For such hybrid clusters, additional policies can be implemented.

In a hybrid cluster, frameworks can be allocated resources from both Appliance(s) and regular servers. In some embodiments, a local Xockets driver can be responsible for the allocation of its local XIMM resources (e.g., CEs). That is, resources in an Appliance can be tracked and managed by the Xockets driver running on the unit processor (e.g., x86s) on the same Appliance.

According to embodiments, in hybrid clusters, Xockets resources can continue to be offered in units of computational elements (CEs). Note, in some embodiments, such CEs may not include the number of host (e.g., x86) processors or cores. In very particular embodiments, appliances can include memory bus mounted XIMMs, and CE resources may be allocated from the unit processor (e.g., x86) driver mastering the memory bus of the appliance (to which the XIMMs are connected).

FIG. 20 shows an allocation of resources operation for an arrangement like that of FIG. 19, according to an embodiment. In the embodiment shown, when running a cluster manager 1902 master on an appliance directly, the cluster manager 1902 master can pass resource allocations to a Xockets driver 1912. Proxy layer 214 can call into the Xockets driver 212 to allocate the physical resources of the appliance (i.e., CEs) to a framework. In this configuration the individual CEs can effectively look like nodes in the cluster 1908. As shown, resources (e.g., CEs) can be requested (1). Available resources can be expressed (2). Resources can then be allocated.

FIG. 21 shows a distribution of cluster manager 2102 in an appliance according to one embodiment. FIG. 21 shows a host processor 2116 of an appliance, as well as two XIMMs 2118-0/1 included in the appliance.

As shown in FIG. 21, in some embodiments, a full cluster manager slave may not run on processor cores (e.g., ARM cores) of XIMMs 2118-0/1 deployed in an appliance. Rather, part of the cluster manager slave can run on a host processor (x86) 2116, when the host is also the cluster manager master. In such an arrangement, a cluster manager master does not communicate directly to the CEs of an appliance (e.g., resources in XIMMs), as direct communication can occur via an XKD (e.g., 1912). Therefore allocation requests of CEs can terminate in the XKD so that it can manage the resources. When running a cluster manager master remotely, a cluster manager can communicate with a host processor (x86) in order to allocate its XIMM resources. In some embodiments, appliance host software can offer the resources of the appliance to the remote cluster manager master as a single node containing a certain number of CEs. The CEs can then be resources private to a single remote node and the remote appliance(s) can look like a computational super-node.

For hybrid clusters, resources can be allocated between Xockets nodes and regular nodes (i.e., nodes made of regular servers). According to some embodiments, a default allocation policy can be for framework resources to use as many Xockets resources as are available, and rely upon traditional resources only when there are not enough of the Xockets resources. However, for some frameworks, such a default policy can be overridden, allowing resources to be divided for best results. As but one very particular example, in a Map-Reduce computation, it is very likely the Mappers or Reducers will run on a regular server processor (x86) and the Xockets resources can be used to ameliorate the shuffle and lighten the burden of the reduce phase, so that Xockets clusters are working cooperatively with regular server nodes. In this example the framework allocation would discriminate between regular and Xockets resources.

Thus, in some embodiments, a cluster manager will not share the same Xockets cluster resources across frameworks. Xockets clusters can be allocated to particular frameworks. In some embodiments, direct communication between a cluster manager master and slaves computational elements can be proxied on the host processor (x86) if the cluster manager master is running locally. A Xockets driver can control the XIMM resources (CEs) and that control plane can be conceptualized as running over the cluster manager.

Referring still to FIG. 21, In some embodiments, Xockets processor (e.g., ARM) cores (one shown as 2119) can run a stripped-down cluster manager slave. A cluster manager layer can be used manage control plane communication between the XKD and the XIMM processors (ARMs), such as the loading, unloading and configuration of frameworks. The Xockets driver (e.g., 19012) can control the XIMM resources and that control plane will run over the cluster manager, where the Xockets driver is proxying the cluster manager when performing these functions.

Thus, in some embodiments, a system can employ a cluster manager for Xocket clusters, but not for sharing Xockets clusters across different frameworks, but for configuring and allocating Xockets nodes to particular frameworks.

Computational Infrastructures according to embodiments will now be described. According to embodiments, systems can utilize appliances for processing unstructured data sets, in various modes, including batch or streaming. The operations on big unstructured data sets are pertinent to the unstructured data and can represent the transformations performed on a data set having its characteristics.

According to embodiments, a computational infrastructure can include a Xockets Software Defined Infrastructure (SDI). A Xockets SDI can minimize porting to the ARM cores of CEs, as well as leverage a common set of transformations across the frameworks that the appliances can support.

According to embodiments, frameworks can run on host processors (x86s) of an appliance. There can be little control plane presence on the XIMM processor (ARM) cores, even in the case the appliance operates as a cluster manager slave. As understood from above, part of the cluster manager slave can run on the unit processor (x86) while only a stripped down and part runs on the XIMM processors (ARMs) (see FIG. 21). The latter part can allow a XKD to control the frameworks running on XIMMs and to utilize the resources on the XIMMs for the data plane. In this way, communication can be reduced to the XIMMs-to-data plane communication primarily, once a XIMM cluster is configured.

If a framework requires more communication with a “Xockets node” (e.g., the Job Tracker communicating with the Task Tracker in Hadoop), such communication can happen on the host processor (x86) between a logical counterpart representing the Xockets node, with the XKD mediating to provide actual communication to XIMM elements.

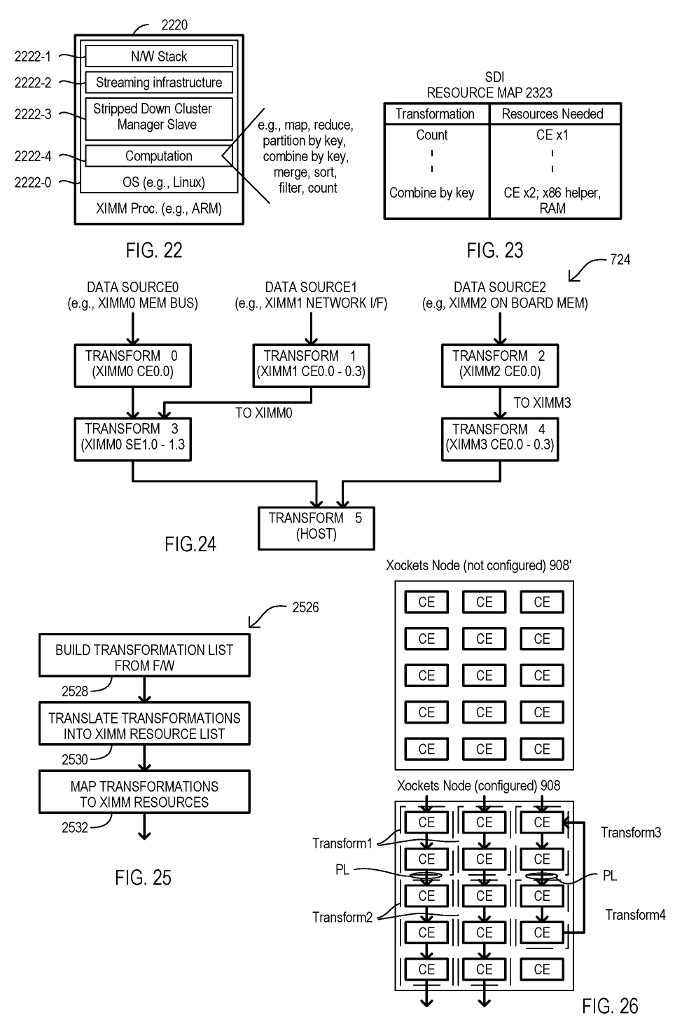

FIG. 22 is an example of processes running on a processor core of a CE (i.e., XIMM processor (ARM) core). As shown, a processor core 2220 can run an operating system (e.g., a version of Linux) 2222-0, a user-level networking stack 2222-1, a streaming infrastructure 2222-2, a minimal cluster manager slave 2222-3, and the relevant computation that gets assigned to that core (ARM) 2222-4.

In such an arrangement, frameworks operating on unstructured data can be implemented as a pipelined graph constructed from transformational building blocks. Such building blocks can be implemented by computations assigned to XIMM processor cores. Accordingly, in some embodiments, the distributed applications running on appliances can perform transformations on data sets. Particular examples of data set transformations can include, but are not limited to: map, reduce, partition by key, combine by key, merge, sort, filter or count. These transformations are understood to be exemplary “canonical” operations (e.g., transformations). XIMM processor cores (and/or any other appliance CEs) can be configured for any suitable transformation.

Thus, within a Xockets node, such transformations can be implemented by XIMM hardware (e.g., ARM processors). Each such operation can take a function/code to implement, such as a map, reduce, combine, sort, etc. FIG. 23 shows how a Xockets SDI have a resource list 2323 for each type of transformation and this can affect the cluster resource allocation. These transformations can be optimally implemented on one or more computational elements of a XIMM. There can be parallel algorithms implemented in the XIMM HW logic, as well as a non-blocking, streaming paradigm that has a very high degree of efficiency. The optimal implementation of a transformation can be considered a Xockets fast path.

Each of the transformations may take input parameters, such as a string to filter on, a key to combine on, etc. A global framework can be configured by allocating the amount of resources to the XIMM cluster that correlates to the normal amount of cluster resources in the normal cluster, and then assigning roles to different parts of the XIMMs or to entire XIMMs. From this a workflow graph can be constructed, defining inputs and outputs at each point in the graph.

FIG. 24 shows a work flow graph according to one particular embodiment. Data can be streamed in from any of a variety of sources (DATA SOURCE0-2). Data sources can be streaming data or batch data. In the particular embodiment shown, DATA SOURCE2 can arrive from a memory bus of a XIMM (XIMM0). DATA SOURCE1 arrives over a network connection (which can be to the appliance or to the XIMM itself). DATA SOURCE2 arrives from memory that is onboard the XIMM itself. Various transformations (TRANSFORM 0 to TRANSFORM 4) can be performed by computing elements residing on XIMMs and some on host resources (TRANSFORM 5). Once one transformation is complete, the results can be transformed again in another resource. In particular embodiments, such processing can be on streams of data.

According to embodiments, framework requests for services can be translated into units corresponding to the Xockets architecture. Therefore, a Xockets SDI can implement the following steps: (1) Determine types of computation that is being carried out by a framework. This is can be reflected in the framework's configuration of a job that it will run on the cluster. This information can result in a framework's request for resources. For example, a job might result in a resource list for N nodes to implement a filter-by-key, K nodes to do a parallel join, as well as M nodes to participate in a merge. These resources are essentially listed out by their transformations, as well as how to hook them together in work-flow graph. (2) Once this list and types of transformations is obtained, the SDI can translate this into the resources required to implement on a Xockets cluster. The Xockets SDI can include a correlation between fundamental transformations for a particular framework and XIMM resources. A Xockets SDI can thus map transformations to XIMM resources needed. At this point any constraints that exist are applied as well (e.g., there might be a need to allocate two computational elements on the same XIMM but in different communication rings for a pipelined computation).

FIG. 25 is a flow diagram showing a process for an SDI 2526. A transformation list can be built from a framework 828. Transformations can be translated into a XIMM resource list 830. Transformations can then be mapped to particular XIMM resources 832 deployed in one or more appliances of a Xockets cluster.

FIG. 26 shows a mapping of transformations to computing elements of a Xockets node. Prior to mapping, a Xockets node 2608′ can be conceptualized as including various CEs. Following a mapping of transformations, a Xockets node 2608 can have CEs grouped and/or connected to create predetermined transforms (Transform1 to 4). Connections, iterations, etc. can be made between transforms by programmed logic (PL) and/or helper processes of the XIMM.

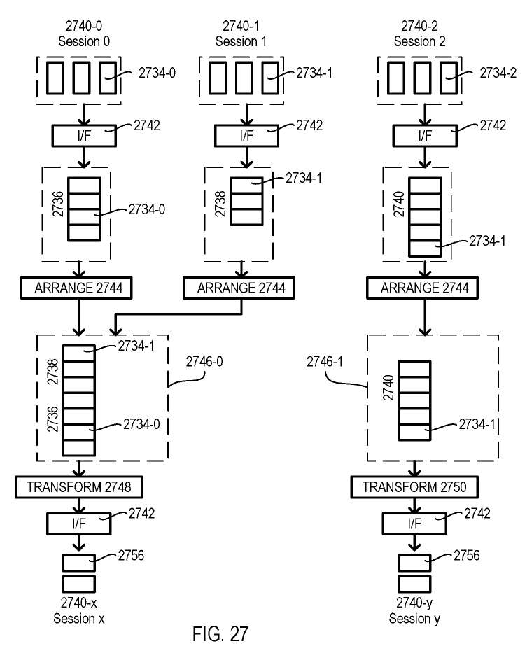

FIG. 27 shows a method according to an embodiment. Data packets (e.g., 2734-0 to -2) from different sessions (2740-0 to -2) can be collected. In some embodiments, packets can be collected over one or more interfaces 2742. Such an action can include receiving data packets over a network connection of server including an appliance and/or over a network connection of an appliance itself, including direct network connections to XIMMs.

Collected packet data can be reassembled into corresponding complete values (2736, 2738, 2740). Such an action can include packet processing using server resources, including any of those described herein. Based characteristics of the values (e.g., 2734-0, 2734-1, 2734-2), complete values can be arranged in subsets 2746-0/1.

Transformations can then be made on the subsets as if they were originating from a same network session (2748, 2750). Such action can include utilizing CEs of a an appliance as described herein. In particular embodiments, this can include streaming data through CEs XIMMs deployed in appliances.

Transformed values 2756 can be emitted as packets on other network sessions 2740-x, 2740-y.

In a particular example, when a system is configured for a streaming data processing (e.g., Storm), it can be determined where data sources (e.g., Spouts) are, and how many of them there are. As but one particular example, an input stream can comes in from a network through a top of the rack switch (TOR), and a XIMM cluster can be configured with the specified amount of Spouts all running on a host processor (x86). However, if input data is sourced off storage of the XIMMs (e.g., an HDFS file system on the flash), the Spouts can be configured to run on the XIMMs, wherever HDFS blocks are read. Operations (e.g., Bolts) can run functions supplied by the configuration, typically something from the list above. For Bolts, frameworks for a filter bolt or a merge bolt or a counter, etc. can be loaded, and the Spouts can be mapped to the Bolts, and so on. Furthermore, each Bolt can be configured to perform its given operation with predetermined parameters, and then as part of the overall data flow graph, it will be told where to send its output, be it to another computational element on the same XIMM, or a network (e.g., IP) address of another XIMM, etc. For example, a Bolt may need to be implemented that does a merge sort. This may require two pipelined computational elements on a same XIMM, but on different communication rings, as well as a certain amount of RAM (e.g., 512 Mbytes) in which to spill the results. These requirements can be constraints placed on the resource allocation and therefore can to be part of the resource list associated with a particular transformation that Storm will use. While the above describes processes with respect to Storm, one skilled in the art would understand different semantics can be used for different processes.

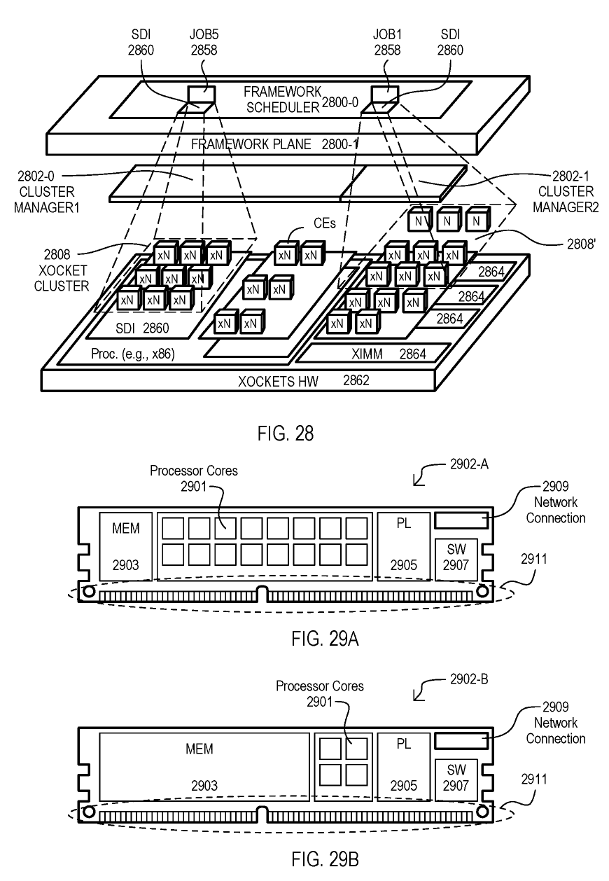

FIG. 28 demonstrates the two levels that framework configuration and computations occupy, and summarizes the overview of a Xockets software architecture according to a particular embodiment. FIG. 28 shows SD's 2860, corresponding jobs 2858, a framework scheduler 2800-0 in a framework plane 2800-1, cluster managers 2802-0/1, CEs of XIMMs (xN), conventional resources (N) a Xocket cluster 2808, a hybrid cluster 2808′, and XIMMs 2864 of a hardware plane 2862.

Canonical transformation that are implemented as part of the Xockets computational infrastructure can have an implementation using Xockets streaming architecture. A streaming architecture can implement transformations on cores (CEs), but in an optimal manner that reduces copies and utilizes HW logic. The HW logic couples input and outputs and schedules data flows among or across XIMM processors (ARMs) of the same or adjacent CEs. The streaming infrastructure running on the XIMM processors can have hooks to implement a computational algorithm in such a way that it is integrated into a streaming paradigm. XIMMs can include special registers that accommodate and reflect input from classifiers running in the XIMM processor cores so that modifications to streams as they pass through the computational elements can provide indications to a next phase of processing of the stream.

As noted above, an infrastructures according to embodiments can include XIMMs in an appliance. FIGS. 29A and 29B show very particular implementations of a XIMM like that of FIG. 4. FIG. 29A shows a computational intensive XIMM 2902-A, while FIG. 29B shows a storage intensive XIMM 2902-B. Each XIMM 2902-A/B can incorporate processor elements (e.g., ARM cores) 2901, memory elements 2903, and programmable logic 2905, highly interconnected with one another. Also included can be a switch circuit 2907 and a network connection 2909

A computational intensive XIMM 2902-A can have a number of cores (e.g., 24 ARM cores), programmable logic 2905 and a programmable switch 2907. A storage intensive XIMM can include a smaller number of cores (e.g., 12 ARM cores) 2901, programmable logic 2905, a programmable switch 2907, and relatively large amount of storage (e.g., 1.5 Tbytes of flash memory) 2903. Each XIMM 2902-A/B can also include one or more network connections 2909.

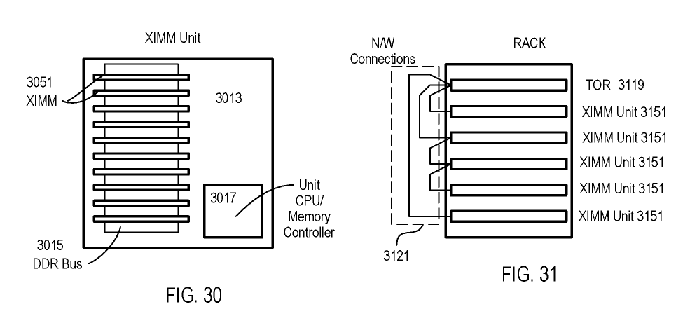

FIG. 30 shows an appliance 3000 according to an embodiment. XIMMs 3051 can be connected together in appliance 3000. XIMMs 3051 of an appliance can be connected to a common memory bus (e.g., DDR bus) 3015. The memory bus 3015 can be controlled by a host processor (e.g., x86 processor) 3017 of the appliance. A host processor 3017 can a XKD for accessing and configuring XIMMs 3051 over memory bus. Optionally, as noted herein, an appliance can include DIMMs connected to the same memory bus (to serve as RAM for the appliance). In particular embodiments, an appliance can be a rack unit.

A network of XIMMs 3051 can form a XIMM cluster, whether they be computational intensive XIMMs, storage intensive XIMMs, or some combination thereof. The network of XIMMs can occupy one or more rack units. A XIMM cluster can be tightly coupled, unlike conventional data center clusters. XIMMs 3051 can communicate over a DDR memory bus with a hub-and-spoke model, with a XXKD (e.g., an x86 based driver) being the hub. Hence over DDR the XIMMs are all tightly-coupled and the XIMMs operate in a synchronous domain over the DDR interconnect. This is in sharp contrast to a loosely-coupled asynchronous cluster.

Also, as understood from above, XIMMs can communicate via network connections (e.g., 2909) in addition to via a memory bus. In particular embodiments, XIMMs 3051 can have has a network connection that is connected to either a top of rack (TOR) or to other servers in the rack. Such a connection can enable peer-to-peer XIMM-to-XIMM communication that do not require a XKD to facilitate the communication. So, with respect to the network connectors the XIMMs can be connected to each other or to other servers in a rack. To a node communicating with a XIMM node through the network interface, the XIMM cluster can appear to be a cluster with low and deterministic latencies. i.e., the tight coupling and deterministic HW scheduling within the XIMMs is not typical of an asynchronous distributed system.

FIG. 31 shows a rack arrangement with a TOR unit 3119 and network connections 3121 between various XIMMs 3151 and TOR unit 3119. It is understood that an “appliance” can include multiple appliances connected together into a unit.

According to embodiments, XIMMs can have connections, and be connected to one another for various modes of operation.

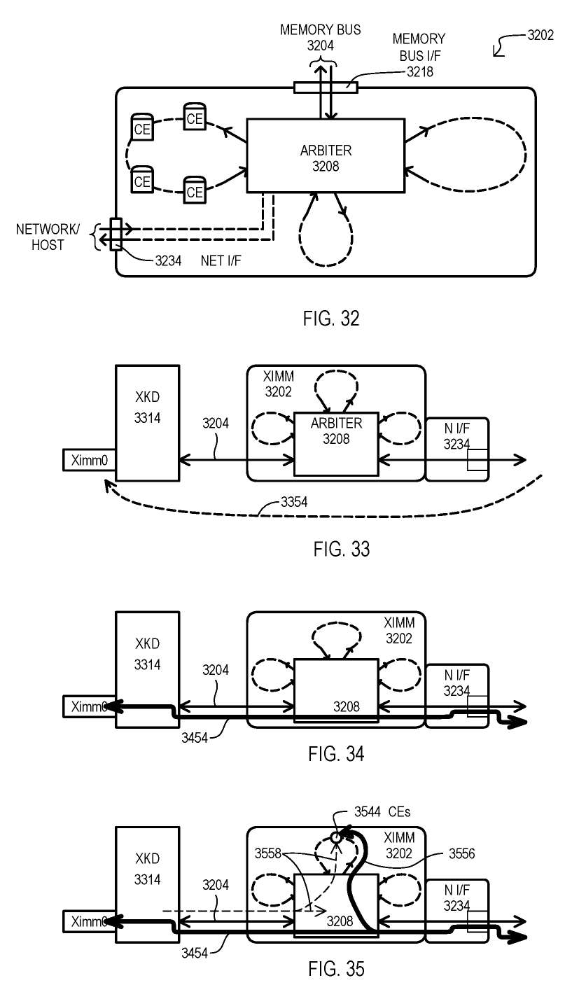

FIG. 32 is a representation of a XIMM 3202. A XIMM 3202 can take the form of any of those described herein or equivalents. XIMM 3202 can include a memory bus interface 3272 for connection to a memory bus 3204, an arbiter 3208, compute elements CE, and a network connection 3234.

As understood, a XIMM can have at least two types of external interfaces, one that connects the XIMMs to a host computer (e.g., CPU) via a memory bus 3204 (referred to as DDR, but not being limited to any particular memory bus) and one or more dedicated network connections 3234 provided on eacg XIMM 3202. Each XIMM 3202 can support multiple network ports. Disclosed embodiments can include up to two 10 Gbps network ports. Within a XIMM 3202, these interfaces connect directly to the arbiter 3208 which can be conceptualized as an internal switch fabric exposing all the XIMM components to the host through DDR in an internal private network.

A XIMM 3202 can be configured in various ways for computation. FIG. 32 shows three computation rings 3274-0 to -2, each of which can include compute elements (CE). A memory bus 3204 can operate at a peak speed of 102 Gbps, while a network connection can have a speed of 20 Gbps.

An arbiter 3208 can operate like an internal (virtual) switch, as it can connect multiple types of media, and so can have multi-layer capabilities. According to an embodiment, core capabilities of an arbiter 3208 can include, but are not limited to, switching based on:

1. Proprietary L2 protocols

2. L2 Ethernet (possibly vlan tags)

3. L3 IP headers (for session redirection)

XIMM network interface(s) 3234 can be owned and managed locally on the XIMM by a computing element (CE, such as an ARM processor) (or a processor core of a CE), or alternatively, by an XKD thread on the host responsible for a XIMM. For improved performance, general network/session processing can be limited, with application specific functions prioritized. For those embodiments in which an XKD thread handles the core functionality of the interface, XKD can provide reflection and redirection services through Arbiter programming for specific session/application traffic being handled on the CE's or other XIMMs on the host.

In such embodiments, a base standalone configuration for a XIMM can be equivalent of two network interface cards (nics), represented by two virtual interfaces on the host. In other embodiments, direct server connections such as port bonding on the XIMM can be used.

In some applications, particularly when working with a storage intensive XIMMs (e.g., FIG. 29A), an Arbiter can act as a L2 switch and have up to every CE in the XIMM own its own network interface.

In some embodiments, during a XIMM discovery/detection phase, an XKD thread responsible for the XIMM can instantiate a new network driver (virtual interface) that corresponds to the physical port on the XIMM. Additionally, an arbiter's default table can be initially setup to pass all network traffic to the XKD, and similarly forward any traffic from XKD targeted to the XIMM network port to it as disclosed in for embodiments herein.

Interfaces for XIMMS will now be described with reference to FIGS. 32-40.

Referring to FIG. 32, Memory based modules (e.g., XIMMs) 3203 can have two type of external interfaces, one 3218 that connects the XIMMs to a host computer (e.g., CPU) via a memory bus 3204 (referred to as DDR, but not being limited to any particular memory bus) and another dedicated network interface 3234 provided by each XIMM. Each XIMM can support multiple network ports. Disclosed embodiments can include up to two 10 Gbps network ports. Within a XIMM, these interfaces connect directly to the arbiter 3208 which can be conceptualized as an internal switch fabric exposing all the XIMM components to the host through DDR in an internal private network.

Arbiter 3208 is in effect operating as an internal (virtual) switch. Since the arbiter connects multiple types of media, it has multi-layer capabilities. Core capabilities include but are not limited to switching based on: Proprietary L2 protocols; L2 Ethernet (possibly vlan tags); and L3 IP headers (for session redirection).

### Interface Ownership

XIMM network interface(s) (3218/3234) can be owned and managed locally on the XIMM by a computing element (CE, such as an ARM processor) (or a processor core of a CE), or alternatively, by a driver (referred to herein as XKD) thread on the host responsible for that XIMM. For improved performance, general network/session processing can be limited, with application specific functions prioritized. For those embodiments in which an XKD thread handles the core functionality of the interface, XKD can provide reflection and redirection services through arbiter 3208 programming for specific session/application traffic being handled on the CE's or other XIMMs on the host.

In this model, the base standalone configuration for a XIMM 3202 can be equivalent of two network interface cards (nics), represented by two virtual interfaces on the host. In other embodiments, direct server connections such as port bonding on the XIMM can be used.

XIMMs 3202 can take various forms including a Compute XIMM and a Storage XIMM. A Compute XIMM can have a number of cores (e.g., 24 ARM cores), programmable logic and a programmable switch. A Storage XIMM can include a smaller number of cores (e.g., 12 ARM cores), programmable logic, a programmable switch, and relatively large amount of storage (e.g., 1.5 Tbytes of flash memory).

In some applications, particularly when working with a Storage XIMM, an arbiter 3208 can act as a L2 switch and have up to every CE in the XIMM own its own network interface.

### Initialization

As shown in FIG. 33, during a XIMM discovery/detection phase, the XKD 3314 thread responsible for the XIMM 3202 can instantiate a new network driver (virtual interface) that corresponds to the physical port on the XIMM. Additionally, the Arbiter's default table can be initially setup to pass all network traffic 3354 to the XKD 3314, and similarly forward any traffic from XKD targeted to the XIMM network port to it as disclosed herein. In a default mode the XIMM can act as a NIC. The virtual device controls the configuration and features available on the XIMM from a networking perspective, and is attached to the host stack.

This ensures that the host stack will have all access to this interface and all the capabilities of the host stack are available.

These XIMM interfaces can be instantiated in various modes depending on a XIMM configuration, including but not limited to: (1) A host mode; (2) a compute element/storage element (CE/SE) mode (internal and/or external); (3) as server extension mode (including as a proxy across the appliance, as well as internal connectivity).

### Network Demarcation

The modes in which the interfaces are initialized have a strong correlation to the network demarcation point for that interface. Table 15 shows network demarcation for the modes noted above.

TABLE 15

| | Network | |
|---|---|---|
| Interface type | Demarcation | Description |
| ximmN.[1-2] | Physical port | Interface representing the XIMMs phys- |
| | (to network | ical ports, currently each XIMM has |
| | or server) | two physical ports. N is the XIMM |
| | | identifier. |
| vce/vseN.[1-12] | Internal | Virtual interfaces for CE/SEs associated |
| | XKD | with XIMM N. CE/SE's are identified |
| | network | as 1-12. There could be multiple of |
| | | these virtual interfaces per CE/SE |
| | | joining disjoint networks. These |
| | | interfaces in the host system are mapped |
| | | to virtual interfaces on the CE/SEs. |
| ce/seN.[1-12] | Physical | When CE/SEs are to be addressable |
| | port the | from the external network. These |
| | network | interfaces are only required when |
| | | CE/SE operate in split stack mode |
| | | and map directly to virtual interfaces |
| | | on the CE/SE. |

### Appliance Connectivity

A XIMM assisted appliance (appliance) can be connected to the external world depending on the framework(s) being supported. For many distributed applications the appliance sits below the top of rack (TOR) switch with connectivity to both the TOR switch and directly attached to servers on the rack. In other deployments, as in the case of support of distributed storage or file systems the appliance can be deployed with full TOR connectivity serving data directly from SE devices in the XIMMs.

Even though the appliance functions in part as a networking device (router/switch) given its rich network connectivity, for particular Big Data appliance applications, it can always terminates traffic. Typically, such an appliance doesn't route or switch traffic between devices nor does it participate in routing protocols or spanning tree. However, certain embodiments can function as a downstream server by proxying the server's interface credentials across the appliance.

### Host Mode

In host mode the XIMM can act like a NIC for the appliance. As shown in FIG. 34, all traffic 3454 arriving on the XIMM network port passes through to the host device and similarly all traffic 3454 sent from the appliance to the XimmA interface can be transparently sent to the network port 3234 on the XIMM 3202. As such the host (appliance) representation of the XIMM network port can match and reflect the characteristics and statistics of that port (e.g., Ethernet).

In this case the host can configure this interface as any other network interface, with the host stack will handling all/any of ARP, DHCP, etc.

Host mode can contribute to the management of the interfaces, general stack support and handling of unknown traffic.

Host Mode with Redirection (Split Stack)

FIG. 35 shows another base case where the XIMM network interface 3234 is acting in Host mode, but specific application traffic is redirected to a CE (or chain of CE's) 3544 in the local XIMM for processing. XKD has a few additional roles in this case: (1) As a client of the SDI it programs the arbiter with the flowspec of the application to be redirected and the forwarding entry pointing to the assigned CE for that session (shown as 3556); (2) the XKD can pass interface information to the CE (shown as 3558), including session information, src and dest IP and MAC addresses so the CE 3544 is able to construct packets correctly. Note that the CE 3544 is not running a full IP stack or other network processes like ARP, so this base interface information can be discovered by XKD and passed to the CE. Update of the CE with any changes on this data can also occur. The SDI on the XKD can program an arbiter 3208 for session redirection. For example, redirection by CEs can be based in IP addresses and ports (i.e., for a compute element CE5: srcIP:*, destIP:A, srcPort:*, destPort:X=CE5). It also communicates interface configuration to a CE.

The CE will be running an IP stack in user space (Iwip) to facilitate packet processing for the specific session being redirected.

Traffic that is not explicitly redirected to a CE through arbiter programming (i.e., 3556) can pass through to XKD as in Host Mode (and as 3454). Conversely, any session redirected to a CE is typically the responsibility of the CE, so that the XKD will not see any traffic for it.

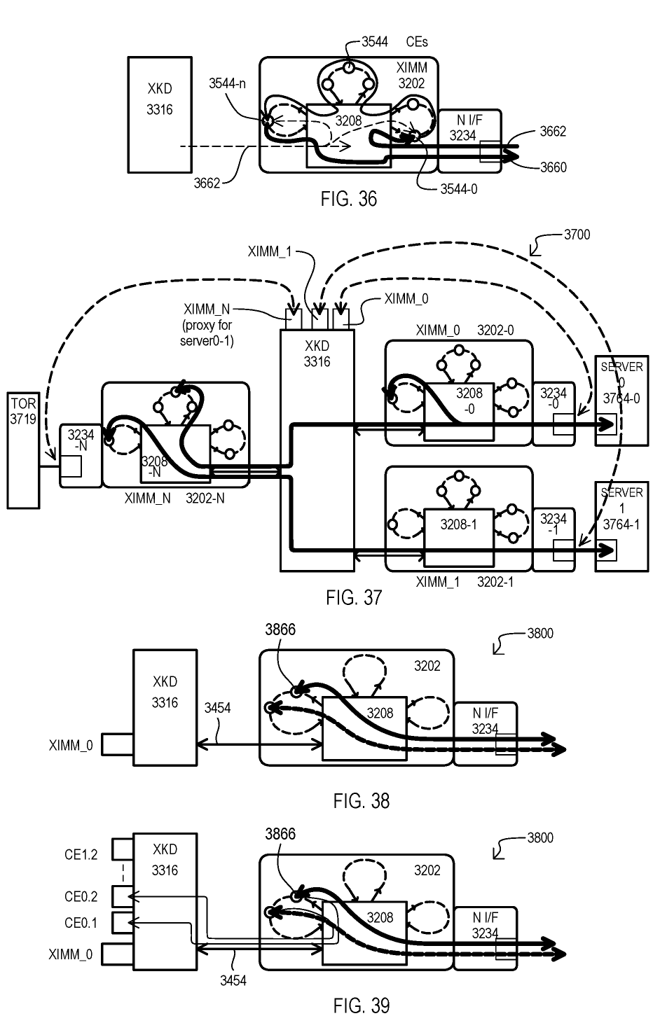

As shown in FIG. 36, In addition to terminating sessions, the XIMM infrastructure can also initiate sessions (3660/3662). Output data 3660 from any of the sessions can be managed locally in the CEs (e.g., 3544) and can be directed to the network interface 3234 without any interference or communication with the host system. In such an outputting of data, the protocol and interface information required for the CEs to construct the output packets (shown as 3662) can be communicated by XKD 3316. such protocol/interface information can (1) program arbiter 3208 for session redirection; (2) cause a first node 3544-0 to terminate a session; (3) cause each node to be programmed to form a processing chain with its next hop; and (4) cause a last node 3544-n to manage an output session.

### TOR Host Masquerading Mode

As shown in FIG. 37, In the case of p2p server connectivity all traffic from a server 3754-0/1 (i.e., sessions to/from the server) can be pinned to a particular server facing XIMM (3202-0, 3202-1). This allows both the arbiter and CEs on the XIMM to be programmed apriori to handle the specific redirected sessions. Pinning specific flows to a XIMM can impose additional requirements when the appliance 3700 is connected to the TOR switch 3719.

In the common environment of many TOR connections, providing the appliance 3700 with a single identity (IP address) towards the TOR network is useful. Link bonding on the appliance 3700 and some load sharing/balancing capabilities can be used particularly for stateless applications. For streaming applications, pinned flows to a specific XIMM are improved if certain traffic is directed to specific XIMM ports in order to maintain session integrity and processing. Such flows can be directed to a desired XIMM (3202-0, 3202-1) by giving each XIMM network port (3234-0/1) a unique IP address. Though this requires more management overhead, it does provide an advantage of complete decoupling from the existing network infrastructure. That identity could be a unique identity or a proxy for a directly connected server.

Another aspect to consider is the ease of integration and deployment of the appliance 3700 onto existing racks. Connecting each server (3754-0/1) to the appliance 3700 and accessing that server port through the appliance (without integrating with the switching or routing domains) can involve extension or masquerade of the server port across the appliance.

In one embodiment, an appliance configured for efficient operation of Hadoop or other map/reduce data processing operations can connect to all the servers on the rack, with any remaining ports connecting to the TOR switch. Connection options can range from a 1 to 1 mapping of server ports to TOR ports, to embodiments with a few to 1 mapping of server ports to TOR ports.

In this case, the network interface instance of the TOR XIMM 3202-N can support proxy-ARP (address resolution protocol) for the servers it is masquerading for. Configuration on the appliance 3700 can include (1) mapping server XIMMs (3202-0/1) to a TOR XIMM (3202-N); (2) providing server addressing information to TOR XIMM 3202-N; (3) configuring TOR XIMM 3202-N interface to proxy-ARP for server(s) address(es); (4) establishing any session redirection that the TOR XIMM will terminate; and (5) establishing a pass-through path from TOR 3719 to each server XIMM (3202-0/1) for non-redirected network traffic.

Referring still to FIG. 37, server facing XIMMs 3202-0/1 are mapped to a TOR facing XIMM 3202-N. Server facing XIMMs 3202-0/1 learn IP addresses of the server to which they are connected. Server facing XIMMs 3202-0/1 communicate to TOR XIMM 3202-N the server addresses being proxied. An arbiter 3208-N of TOR XIMM 3202-N programs a default shortcut for the server IP address to its corresponding XIMM port. XKD 3316 programs any session redirection for the sever destined traffic on the arbiter of either the TOR XIMM arbiter 3208-N or the server facing arbiter 3208-0/1.

### Multi-Node Mode

Referring to FIGS. 38 and 39, multi-node storage XIMM 3202 deployments can be used where data will be served by individual SE's (3866) in the XIMMs 3202. This is an extension of host mode, where each CE or SE on the XIMM complex can have its own network stack and identity.

Approaches to this implementation can vary, depending on whether streaming mode is supported on the XIMM 3202 or each CE/SE 3866 is arranged to operate autonomously. In the latter case, as shown in FIG. 38, each CE/SE 3866 can implement a full stack over one or more interfaces (3454/3234). Each will have its own IP address independent of the XIMM interface on the appliance 3800 and the arbiter 3208 operates as L2 (or L3 switch).

Alternatively, operation in a streaming mode can be enabled by extending the Host model previously described with a split stack functionality. In this case, for each CE/SE 3866 an interface on the host is instantiated to handle the main network stack functionality. Only sessions specifically configured for processing on the CE/SE would be redirected to them and programmed on the arbiter.

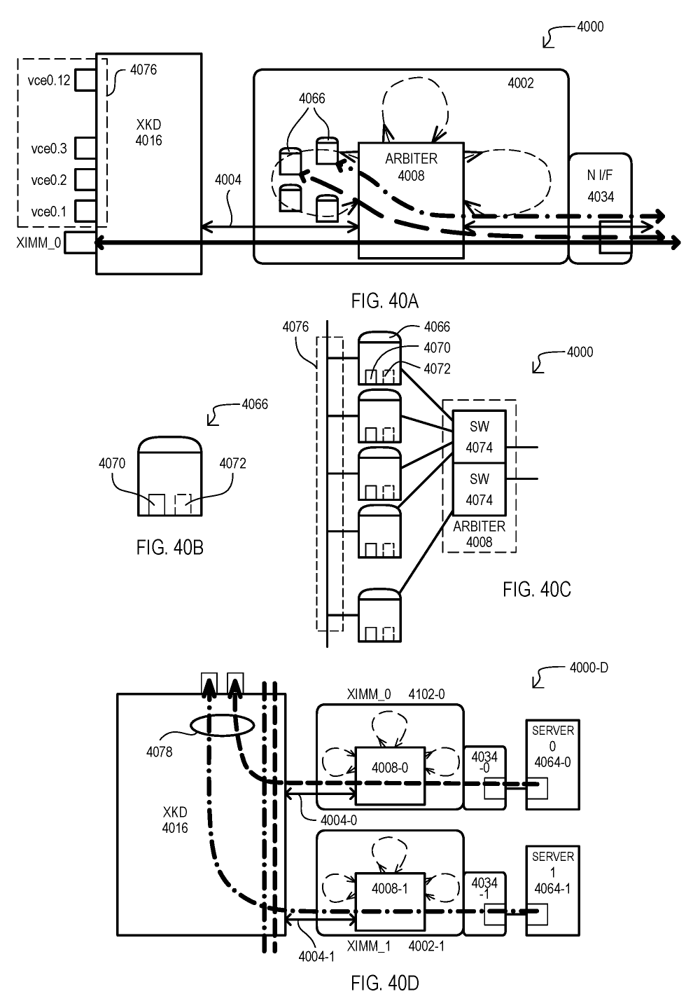

Additionally, referring to FIGS. 40A to 40C, within an appliance 4000, CE/SEs 4044 can be configured with multiple network interfaces. One network interface 4072 can be associated with a network port 4034 on a XIMM 4002 and one or more network interfaces (e.g., 4070) can be associated with a virtual network 4076 over interface 4004. Interfaces 4072 can be switched to the network port (of network interface 4072). There can be two ports per XIMM 4002 so CE/SEs 4044 can be split across the two ports.

As shown in FIG. 40C, an arbiter 4006 can act like a level 2 (L2) switch 4074 between network interface 4072 and interfaces 4072 configured on the CE/SEs 4044. Arbiter 4006 can also forward traffic for interfaces 4070 to XKD 4016. Interfaces for the virtual network 4076 can be configured by a host device (e.g., a linux bridge) for private network connectivity.

FIG. 40D shows other modes for an appliance 4000-D. FIG. 40D shows a NIC extension mode. Network resources of XIMMs 4102-0/1 can be extended to NIC functionality on server. In some embodiments, servers can include software for forming the NIC extensions. As but one example, servers can include a software module that establishes and negotiates connections with the functions of the XIMMs 4102-0/1. In such an embodiment, an interface 4004-0/1 (e.g., DDR3 memory bus bandwidth) can serve as the main interconnect between the XIMMs 4102-0/1 for inter-server (East-West) traffic 4078.

It should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

It is also understood that the embodiments of the invention may be practiced in the absence of an element and/or step not specifically disclosed. That is, an inventive feature of the invention may be elimination of an element.

Accordingly, while the various aspects of the particular embodiments set forth herein have been described in detail, the present invention could be subject to various changes, substitutions, and alterations without departing from the spirit and scope of the invention.

What is claimed is:

1. A system, comprising:
at least one computing module comprising
a physical interface for connection to a memory bus,
a processing section configured to decode at least a predetermined range of physical address signals received over the memory bus into computing instructions for the computing module, and
at least one computing element configured to execute the computing instructions.

2. The system of claim 1, further including:
a controller attached to the memory bus and configured to generate the physical address signals with corresponding control signals.

3. The system of claim 2, wherein:
the control signals indicate at least a read and write operation.

4. The system of claim 2, wherein:
the control signals include at least a row address strobe (RAS) signal and address signals compatible with dynamic random access memory (DRAM) devices.

5. The system of claim 1, further including:
the controller includes a processor and a memory controller coupled to the processor and the memory bus.

6. The system of claim 1, further including:
a processor coupled to a system bus and a memory controller coupled to the processor and the memory bus; wherein
the controller includes a device coupled to the system bus different from the processor.

7. The system of claim 1, further including:
the processing section is configured to decode a set of read physical addresses and a set of write physical addresses for the same computing module, the read physical addresses being different than the write physical addresses.

8. The system of claim 7, wherein:
the read physical addresses are different than the write physical addresses.

9. A system, comprising:
at least one computing module comprising
a physical interface for connection to a memory bus,
a processing section configured to decode at least a predetermined range of physical address signals received over the memory bus into computing instructions for the computing module, and
at least one computing element configured to execute the computing instructions; and
a controller attached to the memory bus and configured to generate the physical address signals with corresponding control signals; and
a controller configured to generate the physical address signals with corresponding control signals.

10. The system of claim 9, wherein:
the at least computing module includes a plurality of computing modules; and
the controller is configured to generate physical addresses for an address space, the address space including different portions corresponding to operations in each computing module.

11. The system of claim 10, wherein:
the address space is divided into pages, and
the different portions each include an integer number of pages.

12. The system of claim 9, wherein:
the processing section is configured to determine a computing resource from a first portion of a received physical address and an identification of a device requesting the computing operation from a second portion of the received physical address.

13. The system of claim 9, wherein:
the controller includes at least a processor and another device, the processor being configured to enable direct memory access (DMA) transfers between the other device and the at least one computing module.

14. The system of claim 9, wherein:
the controller includes a processor, a cache memory and a cache controller; wherein
at least read physical addresses corresponding to the at least one computing module are uncached addresses.

15. The system of claim 9, wherein:
the controller includes a request encoder configured to encode computing requests for the computing module into physical addresses for transmission over the memory bus.

17. A method, comprising:
receiving at least physical address values on a memory bus at a computing module attached to the memory bus;
decoding computing requests from at least the physical address values in the computing module; and
performing the computing requests with computing elements in the computing module.

18. The method of claim 17, wherein:
receiving at least physical address values on a memory bus further includes receiving at least one control signal to indicate at least a read or write operation.

19. The method of claim 17, further including:
determining a type of computing request from a first portion of the physical address and determining a requesting device identification from a second portion of the physical address.

20. The method of claim 17, further including:
encoding computing requests for the computing module into physical addresses for transmission over the memory bus.
